(19) United States
(12) Patent Application Publication
(10) Pub. No.: US 2024/0239001 A1
(43) Pub. Date: Jul. 18, 2024

(54) EDGE COATING OF SUBSTRATES, ESPECIALLY PLATE-SHAPED SUBSTRATES

(71) Applicant: JOWAT SE, Detmold (DE)

(72) Inventors: Ina BENZ, Detmold (DE); Tim GÖRDER, Detmold (DE); Christian TERFLOTH, Detmold (DE)

(21) Appl. No.: 18/576,057

(22) PCT Filed: May 12, 2022
(86) PCT No.: PCT/EP22/62926

§ 371 Date: Jan. 2, 2024

(30) Foreign Application Priority Data
Jul. 2, 2021 (DE) 10 2021 117 136.9
Aug. 11, 2021 (DE) 10 2021 120 894.7
Sep. 1, 2021 (DE) 10 2021 122 622.8

(51) Int. Cl. B27D 5/00; B29D 99/00

(52) U.S. Cl. CPC B27D 5/003; B29D 99/001

(57) ABSTRACT

The present invention relates to a method for edge coating a substrate, in particular a plate-shaped substrate, in addition to a system or a plant for carrying out the method. The invention also relates to a plate-shaped substrate obtained according to said method and to uses thereof.

### CROSS-REFERENCES TO RELATED APPLICATIONS

This application is a National Stage filing of International Application PCT/EP 2022/062926 (WO 2023/274613) filed May 12, 2022, entitled “EDGE COATING OF SUBSTRATES, ESPECIALLY PLATE-SHAPED SUBSTRATES” claiming priority to: DE 10 2021 117 136.9 filed Jul. 2, 2021, DE 10 2021 120 894.7 filed Aug. 11, 2021, and DE 10 2021 122 622.8 filed Sep. 1, 2021.

The subject application claims priority to DE 10 2021 117 136.9, DE 10 2021 120 894.7, DE 10 2021 122 622.8 and PCT/EP 2022/062926 and incorporates all by reference herein, in their entirety.

### BACKGROUND OF THE INVENTION

The present invention relates to the technical field of plastics or adhesive technology and, in particular, to the field of edge coating of, in particular, plate-shaped (material) substrates, such as, for example, plate-shaped wooden or furniture parts, in particular in the form of worktops for kitchens or the like.

In this context, the present invention relates in particular to a method for edge coating (synonymously also referred to as narrow-side coating or narrow-surface coating) of a substrate, in particular a plate-shaped substrate (synonymously also referred to as a material substrate), based on a heat-adhesive (synonymously also referred to as hot-adhesive) thermoplastic strand, wherein the method comprises applying a special printing to the thermoplastic plastic strand or edge coating. As will be further explained below, the plastic strand in the context of the present invention may in particular be configured or present as a plastic profile strand (synonymously also referred to as a plastic profile) or as a plastic film (synonymously also referred to as a plastic film).

The present invention equally relates to a system (synonymously also referred to as a plant) which is in particular suitable for carrying out the method for edge coating according to the invention or is configured for this purpose.

Furthermore, the present invention also relates to the plate-shaped substrate obtainable according to the method according to the invention, having a thermoplastic plastic strand applied to or fixed to at least one edge of the substrate, or an edge coating relating thereto, in particular wherein the plastic strand or the edge coating is provided with a printing. In this context, the present invention also relates to a corresponding plate-shaped substrate as such.

Furthermore, the present invention also relates to the use of a thermoplastic plastic strand for configuring a special edge coating or in the method according to the present invention.

In the producing or cutting to size of, in particular, plate-shaped materials, such as wood, chipboard or the like, which are used in particular in the furniture industry, for example for or as (writing) tables, shelves, decorative elements, (kitchen) worktops or the like, open or unsealed edges often result which, on the one hand, are visually unattractive and, on the other hand, are disadvantageous with regard to the durability or resistance of the underlying materials, for example with regard to the influence of moisture or the like. These edges limit or form in particular the narrow side or surface of the material and are therefore also generally referred to as narrow edges or narrow sides of the plate-shaped material in particular.

In the state of the art, there is a great need to seal or coat edges in order to increase both their optical properties and their durability or stress resistance. For this purpose, prefabricated or conventional edge bands are often used in the prior art, which are applied to the edge, in particular narrow side or narrow edge, using an adhesive, wherein the underlying in particular plate-shaped material acts as substrate or in particular plate-shaped substrate for the edge bands to be applied by means of bonding.

However, the methods known for bonding conventional edgebands are generally relatively costly and are associated with an increased material requirement or consumption, wherein, in addition, an optical adaptation or optical compatibility of the edgeband with respect to the appearance, in particular the decor, of the underlying material can sometimes only be realized to a limited extent or not at all. In addition, based on prefabricated edgebands, subsequent optical adaptation is generally not possible or, at best, can only be realized with great effort.

In the prior art, prefabricated edge bands are thus generally glued typically to plate-shaped substrates, such as a chipboard, MDF panel or the like, for sealing edges (narrow sides, narrow surfaces), such as can be used for tables, cabinets, shelves, (kitchen) worktops, decorative elements, or the like. In this process, a conventional edge tape (e.g., made of PVC, ABS, PP, PMMA, PET, melamine, wood or aluminum or the like) is bonded to the narrow side or narrow surface of the substrate with an adhesive. Usually, in the prior art, conventional edge bands or edge bands to be fixed with the use of an adhesive are applied to the narrow sides or narrow surfaces of plate-shaped substrates in so-called throughfeed machines, such as edge (band) processing machines, with the aid of edge (band) gluing units. In this case, it is generally intended to apply a hot melt adhesive, also known as a “hot melt”, to the narrow surface or narrow side immediately before the edgeband is approached or applied.

The application of conventional edgebands in continuous machines with hotmelt adhesive immediately before the edgeband is started up is basically an established method that is also suitable for producing large quantities. Nevertheless, these methods have a number of disadvantages. For example, an additional adhesive is absolutely necessary, and this may also be in relatively large quantities, so that the resulting adhesive joint between the edgeband and the substrate or carrier material is clearly visible and is often not or cannot be designed satisfactorily from an aesthetic point of view. Furthermore, the use of the adhesive in large quantities when the edgeband is subsequently pressed against the workpiece sometimes causes adhesive to ooze out of the glue line, which leads to soiling of both the workpiece and the processing machine. To prevent this, the workpiece must be treated with release agents before the start of the process, which is time-consuming and costly.

In addition, such methods are not very flexible, since these methods are only economical if large quantities of material coated with edgebands are produced directly, so that even from this point of view, individual design is only possible to a limited extent. In particular, in this context a ready-made static pattern is applied, and the end customer cannot obtain personalized designs, in particular in small quantities.

Due to the previously described disadvantages of this method, alternative ways of applying edgebands to narrow surfaces of plate-shaped workpieces have been sought for some time. Other methods in the prior art attempt to avoid the disadvantages described above, for example by providing edge bands precoated with adhesive, which allow subsequent application to the narrow surface at a flexible time after adhesive application.

Various methods are known in the prior art for producing edgebands precoated with adhesive. Although such methods lead to an improvement with respect to the previously mentioned disadvantages and in particular enable more flexible process operation, they are nevertheless sometimes unsatisfactory in many respects.

One possibility for producing precoated edgebands is coextrusion. In this process, thermoplastic edgebands are produced with a subsequently activatable plastic or adhesive layer, i.e., the producing of the edgeband on the one hand and the admission of plastic or adhesive on the other take place simultaneously, so to speak. Using coextrusion, polymers with a high molecular weight can also be processed, resulting in stable adhesive compounds. However, coextrusion processes require high investment in terms of production equipment since this always has to be individually adapted to the process in question. Consequently, such methods are only economical for large batches; the production of individual configurations, which are not sold in large quantities, is also not economical with this method, wherein in this context also only a limited selection of predetermined samples is available.

In addition, such methods are also sometimes disadvantageous from a technical point of view, since in coextrusion processes the direct compound of thermoplastic edgeband and plastic or adhesive layer must take place without the use of a bonding agent. Due to the lack of an adhesion promoter layer, adequate adhesion can consequently only be achieved between similar or mutually compatible materials.

Overall, there is thus only a limited selection of materials or a limited selection of material combinations that can be used for the production of precoated edgebands. However, the stability or quality of the adhesive bond is sometimes unsatisfactory. The general disadvantages of coextrusion processes described above are also not overcome, and due to the relatively thick adhesive layer that is often present, targeted and efficient reactivation of the adhesive is only possible to a limited extent.

Plastic edgebands produced by coextrusion are known, for example, from EP 1 163 864 A1, DE 10 2006 021 171 A1 and WO 2009/026977 A1.

In addition to producing coated edgebands using coextrusion, it is also possible to coat edgebands with a hotmelt adhesive or hotmelt in so-called offline processes. In these methods, the edgeband is first produced as such and only later coated with a subsequently activatable adhesive, for example by a contract coater or a manufacturer of furniture parts. Such offline processes offer a certain overall flexibility with regard to the edgeband materials to be coated and, due to the cost-effective process operation, also permit the finishing of small batches or quantities. However, such methods can be associated with serious disadvantages: It is particularly problematic that the use of polymers with high molecular weights and low melt indices is not possible, since the high temperatures required for this cannot be achieved in offline operation. Although the edgebandings can be coated much more cost-effectively in such offline processes, the resulting adhesive bonds are often inferior to the edgebandings produced using coextrusion in terms of their service properties.

The melting of the adhesive layer required for subsequent attachment of the edgeband to a material, both of edgebands produced by coextrusion and of postcoated edgebands, is often associated with only a weakly developed or poorly controllable energy transfer to the adhesive, so that heating is relatively protracted or unspecific. In addition, in particular due to the poor controllability, the edgeband itself is typically also heated. However, this is detrimental to the quality of the edgeband, since heating the edgeband can lead to material damage, which in turn results in edgeband materials being limited to insensitive materials.

In addition, the state of the art described above is associated with further problems: Firstly, furniture manufacturers must always store a sufficient quantity of edgeband, which can lead to logistical problems. Secondly, the edge band cannot be individually adapted to the respective edge structure in terms of its (surface) structure and appearance, because it is a prefabricated material that cannot be readily deformed or optically modified. In this context, it is also possible, in particular, that the required quantity of edgebanding in a desired design is not available or, alternatively, that too large a quantity of a particular design is stored, wherein specific storage conditions must additionally be observed so as not to adversely affect the material quality. The methods used in the prior art thus sometimes also require very elaborate and early planning or logistics on the part of the furniture manufacturers.

In particular, supply chains must be precisely adhered to in order to prevent delays in producing the end products. Above all, the producing of the substrate or material and the provision of the specific edgeband must be precisely coordinated in terms of time and space.

In addition, high production and transport costs are incurred because the edgebands are typically not produced by the furniture manufacturer itself. Added to this is the in-house transport from the storage location to the according edge processing or edge banding machines. Subsequently, excess edgebanding or offcuts must either be transported back to the warehouse or disposed of, wherein in particular the disposal of offcuts is uneconomical and inefficient.

### BRIEF SUMMARY OF THE INVENTION

Against this technical background, the object of the present invention is therefore to provide a method for edge coating which at least largely avoids the disadvantages of the prior art described above or is at least capable of mitigating them.

In particular, it is also an object of the present invention to provide a method for edge coating which comprises a high degree of flexibility.

In particular, the present invention is intended to provide a method by means of which an individual optical configuration of the resulting seal or edge coating is made possible, also with respect to an optical adaptation or compatibility to the underlying material part or substrate. In particular, individual adaptation should also be possible within the scope of the process operation itself. In particular, an individual optical configuration or appearance of the edge coating is also to be made possible. In particular, the method is intended to enable a high and individual optical adaptability of the optical design of the coating also with respect to the underlying appearance or appearance of the substrate itself (surface decor), for example with respect to (kitchen) worktops or the like.

Furthermore, it is a further object of the present invention to provide a method for edge coating which is economical and economic, in particular a method in which the amount of raw material required as well as the amount of waste are reduced.

It is also an object of the present invention to provide a method for edge coating by which both transport costs and storage costs can be reduced overall, in particular also of intermediate products.

Moreover, a further object of the present invention is also to provide corresponding plate-shaped substrates, the narrow edge or narrow side of which is comprised of a permanent sealing or (edge) coating which comprises a high resistance or stressability to mechanical stress or environmental influences, such as moisture, UV light or the like.

The object underlying the present invention is solved—according to a first aspect of the present invention—by the method according to the invention for edge coating (narrow side coating, narrow surface coating) of a plate-shaped substrate (material substrate). Further, advantageous configurations of the method according to the invention are similarly provided.

Further subject-matter of the present invention—according to a second aspect of the present invention—is the system (plant) according to the invention, which is designed in particular for carrying out the method according to the invention or for carrying out a method for edge coating, Further, advantageous configurations of the system according to the invention are disclosed.

Again, further subject-matter of the present invention—according to a third aspect of the invention—is the plate-shaped substrate (material substrate), which is configured in particular as a preferably plate-shaped wooden or furniture part, wherein the plate-shaped substrate is obtainable or obtained according to the method according to the invention, as well as also the plate-shaped substrate as such relating thereto, which relate to the plate-shaped substrate according to the invention. Further, advantageous configurations of the substrate according to the invention are described.

Still another subject-matter of the present invention—according to a fourth aspect of the invention—is the use of a heat-adhesive thermoplastic plastic strand for edge coating a plate-shaped substrate in particular, relating to this use.

A further subject-matter of the present invention—according to a fifth aspect of the invention—is furthermore the further use of a heat-adhesive (hot-melt) thermoplastic plastic strand for edge coating of a plate-shaped substrate in particular, relating to this use. Further, advantageous configurations of this use according to the invention are disclosed.

It goes without saying that in the following description of the present invention, such configurations, embodiments, advantages, examples, or the like which are set forth below—for the purpose of avoiding unnecessary repetition—only with respect to a single aspect of the invention, naturally also apply accordingly with respect to the remaining aspects of the invention, without the need for express mention in this regard.

Furthermore, it goes without saying that in the following statements of values, numbers and ranges, the corresponding statements of values, numbers and ranges are not to be understood in a limiting manner; it goes without saying for the person skilled in the art that, depending on the individual case or the application, deviations from the stated ranges or statements can be made without leaving the scope of the present invention.

In addition, it applies that all values or parameters or the like mentioned in the following can in principle be determined or determined with standardized or explicitly stated determination methods or otherwise with determination or measurement methods familiar to the person skilled in the art in this field. Unless otherwise stated, the underlying values or parameters are determined under standard conditions (i.e., in particular at a temperature of 20° C. and/or at a pressure of 1,013.25 hPa or 1.01325 bar).

In addition, it should be noted that in the case of all the relative or percentage, in particular weight-related, quantitative data listed below, these data are to be selected or combined by the person skilled in the art within the scope of the present invention in such a way that in total—if necessary including further components or ingredients, in particular as defined below—always 100% or 100 wt. % results. However, this is self-evident for the person skilled in the art.

With this proviso made, the present invention will be described and explained in more detail below, also on the basis of drawings or figure representations representing preferred embodiments or embodiment examples.

### BRIEF DESCRIPTION OF THE DRAWINGS

FIG. 1A provides a schematic representation of a process sequence according to the invention for edge coating according to a first embodiment.

FIG. 1B provides a schematic representation of a process sequence according to the invention for edge coating according to a further embodiment according to the invention.

FIG. 2A provides a schematic representation of the arrangement of various apparatuses for providing a system (plant) according to the invention in accordance with an embodiment according to the invention.

FIG. 2B provides a schematic representation of the arrangement of various apparatuses for providing a system (plant) according to the invention in accordance with a further embodiment according to the invention.

### DETAILED DESCRIPTION OF THE INVENTION

Thus, the subject-matter of the present invention—according to a first aspect of the present invention—is the method for edge coating (narrow side coating, narrow surface coating) of an in particular plate-shaped substrate (material substrate), preferably a plate-shaped wood and/or furniture part, in particular method for applying an edge coating to at least one edge (narrow side, narrow surface) of a plate-shaped substrate, preferably a plate-shaped wood and/or furniture part, wherein the method comprises the following method steps:
(a) producing a heat-adhesive (hot-adhesive) thermoplastic plastic strand, in particular plastic profile strand (plastic profile) or plastic film (plastic film), preferably in the form of an edge band, preferably using extrusion,
(b) applying and/or fixing, preferably applying and materially bonding and/or permanently fixing, the thermoplastic plastic strand, in particular plastic profile strand or plastic film, to the in particular plate-shaped substrate, in particular to at least one edge (narrow side, narrow surface) of the plate-shaped substrate, in particular in such a way that an edge coating (narrow side coating, narrow surface coating) of the in particular plate-shaped substrate results and/or that a composite of the in particular plate-shaped substrate with the edge coating applied and/or fixed thereto results,
(c) applying a printing onto the thermoplastic plastic strand, in particular plastic profile strand or plastic film, and/or onto the edge coating.

Within the scope of the present invention, a method for edge coating is provided which allows a high degree of flexibility both in terms of design and production and which is economically feasible overall. Most importantly, both the amount of raw material required, and transportation and storage costs are significantly reduced.

In the context of the present invention, the term “narrow side” or “narrow surface” or “edge” refers in particular to a front side of the in particular plate-shaped substrate or material substrate. For example, with reference to the state of use or application of the resulting product, for example a kitchen or worktop, this may be the front edge of the material substrate facing the user, as it were.

In the context of the present invention, the term “flat side” or “flat surface” of the in particular plate-shaped substrate or material substrate refers in particular to the larger side or surface of the substrate in terms of area. For example, in the state of application or use, this can to a certain extent be the upper side of the substrate, which in the case of, for example, worktops or kitchen tops equally represents the working area or the working side and which can generally comprise a decoration or a decorative coating, which can in principle also apply to the underside.

The method according to the invention allows a particularly high degree of flexibility and individual adaptation with regard to the design of the edge coating; in particular, any design can be printed, as it were, on the surface of the plastic strand, so that product manufacturers, for example furniture manufacturers, are not bound by offers from an edge band manufacturer. In this context, the design or the optical configuration of the printing can be specified or set, as it were, on site or immediately prior to the printing process and in the method itself, wherein further optical adaptation to the underlying substrate can also be realized.

In the context of the present invention, it is even possible for the design of the narrow side to be printed on to be adapted exactly to the design of the panel. In this context, for example, the design of the panel can be optically detected or scanned, and the printing is adapted exactly to the design, so that a particularly optically high-quality overall product is produced.

Furthermore, when using the method according to the invention, the production of the overall product, in particular a piece of furniture, is not bound by time restrictions due to availability, ordering and delivery of the edgeband.

Furthermore, according to the invention, a large number of different thicknesses and widths of edge coatings can be produced with the same equipment or system. Also, the material substrates or wood and furniture parts to be coated are essentially not bound to specific dimensions.

Overall, the method according to the invention results in particularly economical production of the corresponding material substrates or furniture parts. In particular, the production of conventional edgebands is not required, which also saves a considerable amount of raw materials, for example with regard to extrudates or the like of conventional edgebands. In addition, for example, no primer and no release agent required for producing conventional edgebands is necessary. Furthermore, the method according to the invention produces at least substantially no offcuts which would subsequently have to be disposed of unused. In addition, the costs of the prior production of the edgebands as well as the transport of these edgebands from the respective producer to the furniture producers as well as the transport from the warehouses to the plants are also eliminated. Furthermore, the method according to the invention also eliminates storage costs, which are often incurred in the prior art for prefabricated conventional edgebands. Overall, the present invention makes a significant economic and ecological contribution by conserving resources.

Within the scope of the method according to the invention, a plate-shaped substrate, in particular a plate-shaped wooden or furniture part, equipped with a thermoplastic plastic strand, in particular in the form of an edge coating based thereon on its narrow side or narrow surface, is thus provided, wherein a special printing is applied onto this thermoplastic plastic strand, or the edge coating based thereon. In the context of the present invention, this is done in particular in such a way that, as will also be indicated in detail below, the thermoplastic plastic strand provided with the printing or the edge coating relating thereto represents the sole or exclusive coating or sealing of the narrow side or narrow surface of the underlying substrate and thus, as it were, the sole coating or delimitation of the narrow side or surface of the substrate, with the omission of a conventional edge band.

Due to the omission of a conventional edge band, there is also no joint between the substrate and the outer boundary in the method according to the invention for the coated material substrate, since the thermoplastic plastic strand itself configures, so to speak, the only coating or boundary of the narrow side. This leads to further improved material properties also in terms of durability and appearance.

The method according to the invention is also characterized by a high degree of modularity of the underlying method steps, wherein the order or sequence of the method steps can also be varied or individually adapted to the underlying requirements. Moreover, in accordance with the invention, it is in particular also the case that, with regard to the modularity of the method according to the invention, the respective steps can be carried out in joint or separately from each other process operations or process spaces, wherein in this respect continuous or discontinuous process operation is also possible. For this reason, too, the method according to the invention can be tailor-made with a high degree of variability.

Against this background, it is possible to proceed in particular as follows according to the invention:
Thus, on the one hand, it may be provided that the method, in particular the overall operation of the method steps (a), (b) and (c), is carried out at least substantially continuously and/or uninterruptedly and/or with at least substantially uninterrupted process operation and/or with at least substantially uninterrupted process operation.
In particular, method steps (a), (b) and (c) are carried out spatially coherently and/or temporally coherently, in particular spatially coherently and temporally coherently.
In particular, the method steps (a), (b) and (c) can be carried out in a joint process operation and/or in a joint process section (system section) or system line and/or in a joint process space (system space), in particular as an in-line method or in-line process.
In this context, in particular, continuous or uninterrupted method or process operation can be carried out or realized, as previously indicated.
On the other hand, according to the invention, it can also be the case that the method, in particular the overall operation of the method steps (a), (b) and (c), is carried out discontinuously and/or not without interruption. For example, after applying or fixing the thermoplastic plastic strand onto the plate-shaped substrate in particular, an interruption of the method can be performed, for example for storage or further transport of the coated plate-shaped substrate for the purpose of applying the print, wherein in this context the method can also be performed in process sections or process spaces separately from each other.
Furthermore, it may be provided in particular that the method steps (a), (b) and (c), in particular the method steps (b) and (c), are carried out at least in part spatially separated from each other and/or temporally separated from each other, in particular spatially separated from each other and temporally separated from each other.
In particular, the method steps (a), (b) and (c), in particular the method steps (b) and (c), are carried out at least in part in from each other separate process operations and/or in from each other separate process spaces (system spaces).
In particular, the method according to the invention can also be carried out as an off-line method or off-line process.

With regard to the above explanations, the method steps can be carried out in the order of (sequence of) (a), (b), (c) or (a), (c), (b) (cf. also the following explanations). The previously stated overall operation of the method steps can thus comprise different sequences with respect to the concrete sequence of the method steps (a), (b) and (c), respectively.

In the context of the present invention, it may furthermore be as follows:
On the one hand, the method steps (a) and (b) can be carried out at least substantially in direct succession and/or at least substantially directly transitioning into one another and/or without carrying out intermediate steps. Thus, according to the invention, it may be provided in particular that the production on the one hand and the applying and/or fixing of the thermoplastic plastic strand on the other hand are transitioned directly into one another and thus carried out to a certain extent simultaneously or jointly, in particular wherein a joint apparatus for production and for applying or fixing on the other hand can also be used for this purpose, as described below. In this way, the thermoplastic plastic strand can be applied on the substrate or fixed in place immediately after or during the producing process, as it were.
According to the invention, it can also be provided that the method steps (a) and (b) are carried out spatially separate from each other or temporally separate from each other, in particular spatially separate from each other and temporally separate from each other.
In particular, method steps (a) and (b) can be carried out in process operations and/or process lines (system line) separate from each other and/or in process spaces (system spaces) separate from each other.
As indicated in detail below, the thermoplastic plastic strand can, for example, be applied in an intermediate step (a′) carried out between the method steps (a) and (b), followed by (c), or between (a) and (c), followed by (b), after it has been produced, on a substrate which is separate and distinct from the workpiece or substrate, optionally followed by printing, and subsequently applied or fixed on the in particular plate-shaped substrate, for example after storage or transport of the thermoplastic plastic strand produced for further processing.

Furthermore, the method according to the invention can also be performed as follows:
Thus, the method steps (b) and (c) can be carried out at least substantially in direct succession and/or at least substantially directly transitioning into each other and/or without carrying out intermediate steps.
In this respect, it may be provided in particular that in a joint process operation and/or in a joint process section or system line and/or in a joint process space (system space) the following can be carried out.
On the other hand, it is also possible to carry out method steps (b) and (c) spatially separate from each other and/or temporally separate from each other, in particular spatially separate from each other and temporally separate from each other.
In particular, method steps (b) and (c) can be carried out in process operations separately from each other and/or in process spaces (system spaces) separate from each other.
Thus, after applying and fixing the thermoplastic plastic strand on the in particular plate-shaped substrate, the method can be interrupted, for example for the purpose of storing the already coated substrate or for the purpose of transporting it for subsequent application of the printing in another process operation or in a process operation separate therefrom. On the other hand, the thermoplastic plastic strand that is first produced and applied to a substrate can also be printed and subsequently applied to the substrate or fixed thereto, for example, in another process chamber or in a separate process operation.

With regard to the above explanations, the method steps can be carried out in the order of (b) and (c) or (c) and (b) (cf. also the following explanations).

According to a preferred embodiment of the invention, the method can be carried out in the order of method steps (a), (b) and (c). In particular, the method can be carried out in the following order of: Method step (a), then method step (b), then method step (c). According to the invention, it can thus be provided in particular that method step (a) is carried out at first, followed by method step (b), again followed by method step (c). With the aforementioned sequence of method steps, particularly good results are obtained, in particular also with regard to the optical properties of the resulting products.

According to a further embodiment of the invention, on the other hand, it may also be provided that the method is carried out in the order of method steps (a), (c) and (b). In this respect, the method can in particular be carried out in the following order of: Method step (a), then method step (c), then method step (b). According to the invention, it can thus be provided that method step (a) is carried out first, followed by method step (c), again followed by method step (b). Thus, in accordance with the invention, it may in particular be the case that method step (c) is carried out before method step (b) and/or after method step (a).

In accordance with the invention, it is in particular the case that the thermoplastic resin strand and/or the material of the thermoplastic resin strand comprises or consists of at least one plastic polymer, in particular adhesive polymer, preferably heat-adhesive (hot melt) thermoplastic resin polymer, preferably heat-adhesive (hot melt) adhesive polymer. By the specific use of such a plastic polymer, defined properties are also achieved for the thermoplastic plastic strand based thereon during its producing and further processing. In particular, the underlying material can be converted into a flowable or heat-adhesive state by heating or can consist thereof. Thus, on the one hand, a defined producing of the plastic strand and, on the other hand, an optimized applying or fixing of the plastic strand on the substrate is ensured, since optimized material properties are present in this respect, which lead to a uniform discharge during the producing and to a firm and permanent fixing on the substrate. For preferred configurations of the plastic polymer, reference can also be made to the following explanations.

In particular, the following should be mentioned with respect to method step (a) or (b):

According to the invention, it is provided in particular that, in particular in method step (a), the thermoplastic plastic strand or the material of the thermoplastic plastic strand, in particular the plastic polymer, in particular as defined below, of the thermoplastic plastic strand, is present in a moldable and/or flowable and/or heat-adhesive state or is converted into such a state. This can be done in particular using heat application (heating), preferably to a temperature above the softening range and/or softening point of the thermoplastic plastic strand and/or the (starting) material used for the thermoplastic plastic strand, in particular plastic polymer. This also ensures a high degree of uniformity with regard to the shaping of the plastic strand during its producing and further improved properties when applying or fixing it on the substrate or carrier. The heating can be carried out, for example, using in particular electrical heating devices or the like.

In addition, in particular in method step (a), the producing of the thermoplastic plastic strand can be effected or carried out using at least one producing apparatus (A). In this respect, the thermoplastic plastic strand can be produced or discharged from the producing apparatus (A) at least substantially uniformly or with at least substantially uniform or at least substantially constant speed (production speed), in particular using nozzle extrusion, preferably slot nozzle extrusion.

In general, according to the invention, in particular in method step (a), the producing of the heat-adhesive thermoplastic plastic strand can be carried out using nozzle(s), in particular nozzle extrusion, preferably slot nozzle extrusion. In contrast, it can also be provided according to the invention that, in particular in method step (a), the producing of the heat-adhesive thermoplastic plastic strand is carried out by means of rollers and/or roller discharge. According to the invention, in particular in method step (a), the producing of the heat-adhesive thermoplastic plastic strand can be carried out using nozzle(s), in particular nozzle extrusion, preferably slot nozzle extrusion, or using rolls and/or roll discharge. According to the invention, however, it is preferred with respect to method step (a) that the producing is carried out by extrusion, in particular slot nozzle extrusion, preferably slot nozzle extrusion.

The thermoplastic plastic strand can be produced, in particular in method step (a), at a speed (production speed) in the range from 1 m/min to 300 m/min, in particular in the range from 10 m/min to 200 m/min, preferably in the range from 20 m/min to 100 m/min. In principle, according to the invention, a generation speed of more than 100 m/min can also be present, for example in the range from more than 100 m/min to 300 m/min.

In accordance with the invention, it may be provided in particular that the thermoplastic plastic strand, preferably in method step (a) and/or in method step (b), is configured or is present at least substantially in the form of a strand, in particular with a longitudinal extent that is greater than the vertical extent.

According to an embodiment of the invention, it may be provided that the thermoplastic plastic strand, in particular the profiled plastic strand, preferably in method step (a) and/or in method step (b), is configured and/or is present as a three-dimensional structure (formation, body), in particular as a profile. In particular, the plastic profile strand can be a three-dimensional structure (formation, body), in particular as a profile. In general, it may in this context in particular be such that the plastic strand configured as a plastic profile strand comprises a relatively large thickness, in particular in the sense of a three-dimensional body, or a larger thickness compared to the configuration as a plastic film. According to the invention, it is thereby provided for the plastic profile strand in particular that both the surface and/or side facing the substrate in the attached or fixed state and the surface and/or side facing away from the substrate are configured to be at least substantially flat and/or at least substantially planar (in particular with respect to the attached or extended state of the plastic strand). In principle, however, even if this is less preferred according to the invention, in particular the surface and/or side of the plastic profile strand facing away from the substrate in the attached or fixed state can comprise a curved and/or bead-shaped and/or arcuate (segment)-shaped and/or circular (section)-shaped profile or a shape in this respect.

According to a further embodiment of the invention, however, it may also be provided that the thermoplastic plastic strand, in particular the plastic film, preferably in method step (a) and/or in method step (b), is configured and/or present as a two-dimensional and/or quasi-two-dimensional structure (formation, body), in particular as a film (foil). In general, it may in this context in particular be that the plastic strand configured as a plastic film comprises a relatively small thickness, in particular in the manner of a two-dimensional or quasi-two-dimensional configuration, or a smaller thickness in comparison with the configuration as a plastic profile strand. In accordance with the invention, it is thereby provided in particular that both the surface and/or side facing the substrate in the attached or fixed state and the surface and/or side facing away from the substrate are configured to be at least substantially flat and/or at least substantially planar (in particular with respect to the flatly extended or stretched state of the plastic strand).

Furthermore, the following can be stated with respect to method step (b):

Thus, in particular in method step (b), it may be provided that the thermoplastic plastic strand is applied or fixed in the formable and/or flowable and/or heat-adhesive (hot-adhesive) state on the in particular plate-shaped substrate, in particular on at least one edge of the plate-shaped substrate, preferably at a temperature above the softening range and/or softening point of the thermoplastic plastic strand and/or of the feature of the thermoplastic plastic strand, in particular plastic polymer.

In this context, it can be in particular such that, in the context of or in particular after the applying or after the fixing on the substrate, cooling takes place in order to solidify the plastic strand or to obtain the edge coating in this respect.

In addition, in particular in method step (b), the thermoplastic plastic strand can be applied and/or fixed at least substantially over the entire surface and/or at least substantially without interruption and/or at least substantially homogeneously and/or with uniform thickness on the in particular plate-shaped substrate, in particular on the at least one edge of the plate-shaped substrate. In this way, a particularly effective and durable sealing is achieved with, at the same time, a good appearance of the underlying narrow side or narrow surface of the plate-shaped substrate. In addition, this reduces the need for post-processing.

In accordance with the invention, it can in particular be provided that, in particular in method step (b), the at least one edge (narrow side) of the plate-shaped substrate is coated with the thermoplastic plastic strand along its entire height and/or its entire length, preferably at least substantially completely and/or over the entire surface.

According to the invention, it may be provided in particular that, in particular in method step (b), the thermoplastic plastic strand is applied or fixed on the in particular plate-shaped substrate, in particular on the edge of the plate-shaped substrate, by means of guiding the substrate along and/or past at least one application and/or fixing apparatus (B).

In addition, in particular in method step (b), the substrate can be guided along and/or past the application and/or fixing apparatus (B), with a uniform and/or linear and/or unidirectional movement. The applying and/or fixing apparatus (B) can in particular be configured as a combined producing and applying and/or fixing apparatus, in particular wherein the producing of the heat-adhesive thermoplastic plastic strand and the applying and/or fixing are carried out in the combined producing and/or applying and/or fixing apparatus, in particular wherein the method steps (a) and (b) are carried out at least substantially in direct succession or in a joint manner.

In principle, however, it is also possible within the scope of the present invention for the substrate to be fixed and the corresponding apparatuses to be guided along or past the substrate, even if this is less preferred in the present case.

According to the invention, it can also be the case that, in particular in method step (b) and/or in particular in the course of and/or after the applying or fixing of the thermoplastic plastic strand, shaping (synonymously also referred to as formatting or formatting), in particular further shaping (further formatting or further formatting), of the thermoplastic plastic strand takes place.

The term “shaping” (synonymously also referred to as formatting or formatting), as used in the context of the present invention, is to be understood very broadly. In particular, shaping refers to a (further) shaping of the physical form or to a (further) physical configuration of the thermoplastic plastic strand or of the resulting edge coating. In this context, the shaping or formatting can in particular be accompanied by a (further) mechanical processing and/or a (further) mechanical shaping in particular of the thermoplastic plastic strand, for example with regard to a (further) setting or standardization, for example, of the thickness and/or the height (width) and/or a (further) surface and/or edge processing or the like of the thermoplastic plastic strand. In this way, a further optimized physical configuration of the thermoplastic plastic strand can be realized for providing a corresponding edge coating, in particular with further improved sealing properties and optical properties (homogeneous appearance). In particular, this can result in further improved adaptation to the underlying substrate.

In particular, method step (b) of the method according to the invention can thus be designed as follows:
(b) applying and/or fixing, preferably applying and material bonding and/or permanently fixing, the thermoplastic plastic strand, in particular plastic profile strand or plastic film, to the in particular plate-shaped substrate, in particular to at least one edge of the plate-shaped substrate, in particular in such a way, in particular on at least one edge of the plate-shaped substrate, in particular in such a way that an edge coating of the in particular plate-shaped substrate results and/or that a bond of the in particular plate-shaped substrate with the edge coating applied thereto and/or fixed thereto results, in particular wherein during and/or after the application and/or fixing a shaping in particular a further shaping of the thermoplastic plastic strand takes place and/or is carried out.

Thus, in accordance with this aspect, the present invention also relates in particular to the method for edge coating a substrate, in particular a plate-shaped substrate, preferably a plate-shaped wood and/or furniture part, in particular to a method for applying an edge coating onto at least one edge of a plate-shaped substrate, preferably a plate-shaped wood and/or furniture part,

wherein the method comprises the following method steps:
(a) producing a heat-adhesive (hot-adhesive) thermoplastic plastic strand, in particular plastic profile strand (plastic profile) or plastic film (plastic film), preferably in the form of an edge band, preferably using extrusion,
(b) applying and/or fixing, preferably applying and material bonding and/or permanently fixing the thermoplastic plastic strand, in particular plastic profile strand or plastic film, to the in particular plate-shaped substrate, in particular to at least one edge of the plate-shaped substrate, in particular in such a way, in particular on at least one edge of the plate-shaped substrate, in particular in such a way that an edge coating of the in particular plate-shaped substrate results and/or that a bond of the in particular plate-shaped substrate with the edge coating applied thereto and/or fixed thereto results, in particular wherein during and/or after the application and/or fixing a shaping in particular a further shaping of the thermoplastic plastic strand takes place and/or is carried out,
(c) applying a printing onto the thermoplastic plastic strand, in particular plastic profile strand or plastic film, and/or onto the edge coating.

In addition, method step (b) of the method according to the invention can in particular also be designed as follows:
(b) applying and/or fixing, preferably applying and material bonding and/or permanently fixing, the thermoplastic plastic strand, in particular plastic profile strand or plastic film, on the in particular plate-shaped substrate, in particular on at least one edge of the plate-shaped substrate, optionally under and/or followed by shaping of the thermoplastic plastic strand, in particular in such a way that an edge coating of the in particular plate-shaped substrate results and/or that a bond of the in particular plate-shaped substrate with the edge coating applied thereto and/or fixed and optionally shaped results.

Consequently, according to this aspect, the present invention relates in particular also to the method for edge coating a particularly plate-shaped substrate, preferably a plate-shaped wood and/or furniture part, in particular to methods for applying an edge coating onto at least one edge of a plate-shaped substrate, preferably a plate-shaped wood and/or furniture part,

wherein the method comprises the following method steps:
(a) producing a heat-adhesive (hot-adhesive) thermoplastic plastic strand, in particular plastic profile strand (plastic profile) or plastic film (plastic film), preferably in the form of an edge band, preferably using extrusion,
(b) applying and/or fixing, preferably applying and material bonding and/or permanently fixing, the thermoplastic plastic strand, in particular plastic profile strand or plastic film, on the in particular plate-shaped substrate, in particular on at least one edge of the plate-shaped substrate, optionally under and/or followed by shaping of the thermoplastic plastic strand, in particular in such a way that an edge coating of the in particular plate-shaped substrate results and/or that a bond of the in particular plate-shaped substrate with the edge coating applied thereto and/or fixed and optionally shaped results.
(c) applying a printing onto the thermoplastic plastic strand, in particular plastic profile strand or plastic film, and/or onto the edge coating.

According to the invention, in particular in method step (b), the applying and/or fixing on the in particular plate-shaped substrate, in particular on the edge (narrow side) of the plate-shaped substrate, or the (further) shaping can be effected or carried out by means of nozzle application, preferably slot nozzle application, roller application, scraper, spraying, calendering, printing processes, in particular by means of nozzle application or extrusion and/or roller application, preferably nozzle application, preferably slot nozzle application.

Thus, in particular, nozzle application devices, in particular slot nozzle application devices, roller application devices, scraper application devices, spray application devices, calender application devices or printing devices can be used in particular with respect to the aforementioned apparatus (B).

In this context, the apparatus (B) can also serve to (further) format the thermoplastic plastic strand. In this respect, the apparatus (B) can thus be configured as an application and/or fixing and/or shaping apparatus, so to speak. In contrast, however, a separate shaping device can also be used (which can then be arranged in particular downstream and/or downstream in the process direction from the apparatus (B)), in particular with regard to further shaping of the thermoplastic plastic strand.

As previously indicated, according to the invention, in particular in method step (b), the applying or fixing of the thermoplastic plastic strand on the in particular plate-shaped substrate, in particular on the at least one edge of the plate-shaped substrate, and/or the shaping, in particular the further shaping, can be effected directly and/or immediately and/or without carrying out intermediate steps and/or without intermediate layers, i.e. the plastic strand is applied or fixed or formatted during its producing or immediately thereafter. This is associated with the advantage that the thermoplastic plastic strand is already in a flowable or heat-adhesive state and does not have to be heated again.

According to the invention, in accordance with a particularly preferred embodiment, it is in particular the case that, in particular in method step (b), the applying and/or fixing of the thermoplastic plastic strand on the in particular plate-shaped substrate, in particular on the at least one edge of the plate-shaped substrate, is carried out without additional adhesive or without an additional adhesive layer. In the context of the present invention, this is made possible in particular by the fact that the thermoplastic plastic strand or the edge coating relating thereto itself acts as an adhesive and thus comprises bonding and sealing properties at the same time. According to the invention, the applying or fixing of the thermoplastic plastic strand is thus effected substantially or exclusively by the inherent heat-adhesiveness or inherent hot-adhesiveness of the thermoplastic plastic strand or of the materials used for this purpose, wherein, moreover, the use of conventional edge tapes can be dispensed with.

In this context, it is provided in accordance with the invention in particular that, in particular in method step (b), the thermoplastic plastic strand is fixed on the in particular plate-shaped substrate, in particular on the at least one edge of the plate-shaped substrate, preferably exclusively as a result of and/or by the inherent (heat) tackiness of the thermoplastic plastic strand.

In principle, a mechanical pretreatment of the substrate, in particular of the edge of the substrate, can be effected prior to application or fixing and/or prior to producing the thermoplastic plastic strand, in particular to the effect that a smoothing of the edge surface or the like is carried out. For example, if a very smooth edge is present, a targeted roughening of the edge surface can also be effected before application or fixing.

Furthermore, according to a first embodiment, it may be in accordance with the invention, in particular before applying and/or fixing the thermoplastic plastic strand, that the plate-shaped substrate (for example if it is made of plastic), in particular the edge of the plate-shaped substrate, is provided with at least one adhesion promoter (primer) and/or is subjected to a pre- and/or surface treatment and/or activation, preferably using corona or plasma treatment. This can ensure improved adhesion of the thermoplastic plastic strand on the edge of the substrate. According to this embodiment, it may in particular be the case that at least the edge of the plate-shaped substrate and/or the plate-shaped substrate as such is formed from or consists of plastic.

On the other hand, according to a further embodiment, it can also be provided that in method step (b) the applying and/or fixing of the thermoplastic plastic strand on the in particular plate-shaped substrate, in particular on the at least one edge (narrow side) of the plate-shaped substrate, without use of an adhesion promoter (primer) and/or without pretreatment and/or surface treatment and/or activation of the plate-shaped substrate, in particular without use of an adhesion promoter for the edge of the plate-shaped substrate, and/or without pretreatment of the thermoplastic plastic strand, in particular without pretreatment of the side and/or surface of the thermoplastic plastic strand to be applied on the substrate, is effected and/or is carried out, respectively, without pretreatment of the side and/or surface of the thermoplastic plastic strand to be applied on the substrate, in particular without pretreatment of the side and/or surface of the thermoplastic plastic strand to be applied on the substrate, in particular without pretreatment of the side and/or surface of the thermoplastic plastic strand to be applied on the substrate. is carried out. This is accompanied by a corresponding further simplification of the method according to the invention, in particular for the case of particularly effective heat- or heat-adhesive materials for the thermoplastic plastic strand.

According to the invention, in particular in method step (b), the applying and/or fixing of the thermoplastic plastic strand can be effected at a speed (applying or fixing speed) in the range from 1 m/min to 300 m/min, in particular in the range from 10 m/min to 200 m/min, preferably in the range from 20 m/min to 100 m/min. In principle, according to the invention, an applying or fixing speed of more than 100 m/min can also be present, for example in the range from more than 100 m/min to 300 m/min. The applying or fixing speed can correspond to or be synchronized with the producing speed mentioned above for method step (a), in particular according to the case that the producing and the applying or fixing are carried out in immediate succession or within the framework of continuous process control.

In general it can be, in particular in method step (b), that the thermoplastic plastic strand is applied in an amount in the range of 50 g/m² to 1,500 g/m², in particular in the range of 100 g/m² to 1,200 g/m², preferably in the range of 150 g/m² to 1,000 g/m², preferably in the range from 200 g/m² to 800 g/m², in particular preferably in the range from 250 g/m² to 800 g/m², based on the dry weight of the thermoplastic strand, is applied and/or fixed to the in particular plate-shaped substrate, in particular on the edge of the plate-shaped substrate. Using the above-mentioned quantities, a sufficiently thick edge coating can be ensured, and this at the same time with a high homogeneity of the formed edge coating.

According to the invention, in particular in method step (b), the thermoplastic plastic strand can be applied and/or fixed with a thickness in the range from 0.05 mm to 3 mm, in particular in the range from 0.075 mm to 2 mm, preferably in the range from 0.1 mm to 1.5 mm, more preferably in the range from 0.15 mm to 1.25 mm, even more preferably in the range from 0.175 mm to 1 mm, most preferably in the range from 0.2 mm to 0.9 mm, further preferably in the range from 0.25 mm to 0.8 mm, on the in particular plate-shaped substrate, in particular on the at least one edge of the plate-shaped substrate.

In this context, the thermoplastic plastic strand or the edge coating can comprise a thickness in the range from 0.05 mm to 3 mm, in particular in the range from 0.075 mm to 2 mm, preferably in the range from 0.1 mm to 1.5 mm, preferably in the range from 0.15 mm to 1.25 mm, more preferably in the range from 0.175 mm to 1 mm, most preferably in the range from 0.2 mm to 0.9 mm, further preferably in the range from 0.25 mm to 0.8 mm. In this respect, it can also be provided according to the present invention that, in particular in method step (a), the thermoplastic plastic strand is produced with the aforementioned thicknesses.

Within the scope of the present invention, it is particularly provided that, in particular in method step (b), the thermoplastic plastic strand applied and/or fixed on the in particular plate-shaped substrate is converted into a non-flowable or solid (solidified) or at least partially cured state, in particular by cooling, preferably by cooling on temperatures below the softening range or softening point of the thermoplastic plastic strand or of the material of the thermoplastic plastic strand, in particular plastic polymer. In this way, the edge coating can be obtained or configured, in particular wherein the edge coating is comprised in a non-flowable or solid (solidified) or at least partially cured state. By this means, a permanent and durable or resistant sealing of the edge (narrow side, narrow surface) of the substrate can be provided.

Thus, according to the invention, it may be provided in particular that, in particular in method step (b), cooling of the thermoplastic plastic strand applied and/or fixed on the in particular plate-shaped substrate is carried out, in particular to a temperature below the softening range and/or softening point of the thermoplastic plastic strand and/or of the material of the thermoplastic plastic strand, in particular plastic polymer, or in particular to configure and/or obtain the edge coating in a non-flowable and/or solid (solidified) and/or at least partially cured form. According to cooling devices can be used for this purpose, such as (cooling) blowers or the like.

The curing of the applied and/or fixed thermoplastic plastic strand or edge coating can be initiated and/or accelerated after it has been applied and/or fixed, for example by radiation, UV and/or heat influence. Appropriate apparatuses, such as UV lamps or the like, can also be used for this purpose.

According to a first embodiment according to the invention, it is provided in particular that the thermoplastic plastic strand produced in method step (a) is applied and/or fixed on the in particular plate-shaped substrate, in particular on the edge (narrow side) of the plate-shaped substrate, at least substantially immediately following its producing and/or at least substantially immediately following method step (a) in method step (b). As previously stated, method steps (a) and (b) can be combined or carried out as a joint method step.

In this context, applying the thermoplastic plastic strand can in particular take effect in the moldable and/or flowable and/or heat-adhesive state.

However, according to a further configuration of the method according to the invention which is alternative to the embodiment mentioned above, it can also be provided that, in particular after method step (a), preferably at least substantially immediately after method step (a), and/or in particular before method step (b) and/or before method step (c), at least one intermediate step, in particular at least one intermediate step according to method step (a′), is carried out.

In this context, the method according to the invention can be carried out in the order of (sequence of) method steps (a), (a′), (b) and (c). In contrast, however, the method according to the invention can also be carried out in the order (sequence) of the method steps (a), (a′), (c) and (b) in this context. However, carrying out the method according to the invention in the order (sequence) of the method steps (a), (a′), (b) and (c) is preferred.

In this context, the following can be carried out with respect to the intermediate or method step (a′):

Thus, as an intermediate step, in particular as an intermediate step according to method step (a′), an applying and/or fixing, preferably applying and detachable and/or intermediate (non-permanent) fixing, of the thermoplastic plastic strand, in particular plastic profile strand or plastic film, on a support can be carried out.

According to the invention, it can thus be provided that the thermoplastic plastic strand produced in method step (a) is not applied or fixed directly on the substrate or the edge thereof, but is first applied onto a carrier, so that subsequently an applying or fixing on the substrate or a printing can be carried out, i.e., starting from the thermoplastic plastic strand previously applied onto the carrier. Applying on a carrier can thereby be effected, for example, with regard to discontinuous process operation or, when carrying out the method according to the invention, in separate process operations or in separate process spaces. Applying the thermoplastic plastic strand on the carrier can further enable spatial and temporal separation of method steps (a) on the one hand and (b) and (c) on the other.

In this context, the thermoplastic plastic strand fixed on the carrier can also be (temporarily) stored or transferred to further processing areas for further processing within the method according to the invention.

The applying and/or fixing on the substrate can equally be carried out by means of nozzle application, preferably slot die application, roller application, scraping, spraying, calendering, printing processes, in particular by means of nozzle application or extrusion and/or roller application, preferably slot die application. For this purpose, according to method step (b), corresponding application and fixing apparatuses or combined producing and application or fixing apparatuses can also be used.

In addition, during and/or after applying and/or fixing the thermoplastic plastic strand on the substrate, shaping (synonymously also referred to as formatting or formatting), in particular further shaping (i.e., starting from the producing of the plastic strand), of the thermoplastic plastic strand can be effected or carried out, for example, by using appropriate shaping devices or means, such as rollers or scraper devices (scrapers) or the like.

In general, according to method step (a′) in particular, the thermoplastic plastic strand can be applied or fixed on the support by using the support to move along or past the corresponding producing or applying or fixing apparatus. In addition, in particular in method step (a′), the carrier can be guided along or past the corresponding apparatus with a uniform or rectilinear or unidirectional movement. According to the invention, however, it can also be provided that the carrier is fixed, and the corresponding apparatus is moved along or past the carrier, in particular with a uniform or rectilinear or unidirectional movement, for the purpose of applying or fixing the thermoplastic plastic strand on the carrier.

With regard to the carrier provided according to method step (a′), this is generally a flat or two-dimensional material. In particular, the carrier comprises at least one surface or side for receiving the thermoplastic plastic strand.

Generally, the carrier may comprise or consist of a carrier material selected from the group consisting of preferably heat-resistant paper, preferably heat-resistant paperboard, metal, preferably heat-resistant plastic, wood, and combinations thereof. In this context, it is also possible to carry out a rolling up of the thermoplastic plastic strand applied or fixed and cooled on the support, for example to enable storage or transport.

According to the invention, in particular in method step (a′), the thermoplastic plastic strand can be applied in an amount in the range from 50 g/m2 to 1,500 g/m2, in particular in the range from 100 g/m² to 1,200 g/m², preferably in the range of from 150 g/m² to 1,000 g/m², preferably in the range of from 200 g/m² to 800 g/m², more preferably in the range of from 250 g/m2 to 800 g/m², based on the dry weight of the thermoplastic plastic strand and/or on the material of the thermoplastic plastic strand, are applied and/or fixed on the substrate.

In general, in particular in method step (a′), the thermoplastic plastic strand having a thickness in the range from 0.05 mm to 3 mm, in particular in the range from 0.1 mm to 1.75 mm, preferably in the range from 0.2 mm to 1 mm, preferably in the range from 0.3 mm to 0.85 mm, can be applied and/or fixed on the support.

In addition, in particular in method step (a′), the thermoplastic plastic strand can be applied or fixed on the substrate at least substantially over the entire surface and/or at least substantially without interruption and/or at least substantially homogeneously and/or with uniform thickness.

The thermoplastic plastic strand can preferably be applied and/or fixed on the substrate with edge spacing, in particular along the longitudinal side of the substrate or plastic strand. In particular, this results in a carrier edge region which is not provided with the thermoplastic plastic strand. This can facilitate the detachment of the carrier for subsequent further processing of the thermoplastic plastic strand.

According to the invention, it may be provided in particular that, in particular in method step (a′), the thermoplastic plastic strand applied and/or fixed to the support is or is converted into a non-flowable and/or solid (solidified) and/or at least partially cured state, in particular by cooling, preferably by cooling to temperatures below the softening range and/or softening point of the thermoplastic plastic strand and/or of the material of the thermoplastic plastic strand, in particular plastic polymer.

In this respect, in particular in method step (a′), cooling of the thermoplastic plastic strand applied and/or fixed to the support can be effected, in particular to a temperature below the softening range and/or softening point of the thermoplastic plastic strand and/or of the (starting) material used for the thermoplastic plastic strand, in particular plastic polymer. Accordingly, cooling devices can be used for this purpose, such as (cooling) blowers or the like.

Within the scope of the present invention, the thermoplastic plastic strand applied and/or fixed on the substrate in particular in method step (a′) and converted into and/or present in a non-flowable and/or solid (solidified) and/or at least partially cured state can subsequently be equipped or provided with a printing according to method step (c). In particular, this can also be effected prior to carrying out method step (b) or prior to application and fixing on the plate-shaped substrate in particular.

In this respect, the method according to the invention can in particular be carried out in the order of method steps (a), (a′) (c) and (b). The printing according to method step (c) of the thermoplastic plastic strand is carried out in particular in the solid or non-heat-adhesive (non-hot-adhesive) state of the thermoplastic plastic strand applied onto the substrate.

Thus, according to the invention, it may be provided that an already printed thermoplastic plastic strand is subsequently applied and/or fixed according to method step (b) on the in particular plate-shaped substrate for obtaining, as it were, an already pre-printed edge coating.

In contrast, however, it can also be provided in accordance with the invention that the thermoplastic plastic strand applied to the substrate in accordance with method step (a′), in particular after storage or the like thereof, is applied and/or fixed on the in particular plate-shaped substrate in accordance with method step (b) and subsequently the thermoplastic plastic strand thus applied and/or fixed or the edge coating thus obtained is printed in accordance with method step (c). Thus, the method can in particular also be carried out in the order of method steps (a), (a′), (b) and (c).

According to the invention, it is provided in particular that the thermoplastic plastic strand applied and/or fixed on the substrate, in particular in method step (a′), is detached from the substrate, in particular by applying heat (heating), and/or is converted again into a moldable and/or flowable and/or heat-adhesive strand, in particular for the purpose of subsequently carrying out method step (b), in particular using heat application (heating), in particular at a temperature above the softening range and/or softening point of the thermoplastic plastic strand and/or the (starting) material used for the thermoplastic plastic strand, in particular plastic polymer.

Furthermore, the thermoplastic plastic strand obtained in method step (a′) can subsequently be applied and/or fixed on the in particular plate-shaped substrate, in particular on the edge of the plate-shaped substrate, using roller application, scraper and/or calendering, in particular using roller application, according to method step (b). As previously stated, the thermoplastic plastic strand can be printed in this case before carrying out method step (b) using method step (c), so that an already printed thermoplastic plastic strand can be applied onto or fixed to the plate-shaped substrate in particular or to the edge thereof. In contrast, however, an unprinted thermoplastic plastic strand can also be applied and/or fixed in accordance with method step (b), followed by the printing, provided in accordance with method step (c), of the thermoplastic plastic strand applied onto the in particular plate-shaped substrate or its edge or of the edge coating relating thereto.

As far as the method according to the invention is concerned, it may further be provided that the thermoplastic plastic strand is based on a plurality of layers or is built up on the basis of a plurality of layers. In this context, it can in accordance with the invention in particular be such that, in particular before carrying out method step (c), method steps (a) and (b) or method steps (a) and (a′) are repeated or carried out again in such a way that a multilayer or thermoplastic plastic strand based on a plurality of layers results. In this respect, the thermoplastic plastic strand may comprise or be based on two, three, four or more layers. In particular, the procedure is such that in method step (b) or (a′) the applying and/or fixing on the plate-shaped substrate or the edge thereof or the support is carried out to the extent that at least one thermoplastic plastic strand is already arranged between the substrate or the edge thereof or the support and the further plastic strand to be applied and/or fixed. In this case, the thermoplastic plastic strands or the related material layers can transition into one another or, as it were, fuse with each other (in particular so that, despite multiple coatings, a uniform plastic strand or a uniform edge coating, as it were, results).

According to the invention, several, in particular at least two, three, four or more, layers of the thermoplastic or heat-adhesive material can thus be applied successively to configure the thermoplastic plastic strand, in particular in accordance with method step (b), on the in particular plate-shaped substrate, in particular on the edge of the plate-shaped substrate, or applied and/or fixed on the substrate in accordance with method step (a′), as it were in a layer-on-layer arrangement or application, in particular by repeatedly carrying out method steps (a) and (b) on the one hand or by repeatedly carrying out method steps (a) and (a′), in particular with subsequent carrying out of method step (b), on the other hand.

The structure based on several layers can be obtained by repeatedly passing the substrate on the according producing or applying or fixing apparatuses.

As far as the method according to the invention is further concerned, in particular in method step (b) and/or in method step (a′), preferably in method step (b), a surface treatment, in particular surface smoothing and/or surface homogenization, of the plastic strand and/or of the edge coating, in particular in a non-flowable and/or solid (solidified) and/or at least partially cured state, preferably of the side and/or surface and/or of the edge regions of the thermoplastic plastic strand and/or of the edge coating facing away from the substrate and/or the support, can be effected and/or carried out.

In this context, the surface treatment, in particular surface smoothing, can be carried out in a non-restrictive manner, for example, using milling, grinding, preferably calibration grinding, cutting, smoothening and/or polishing. In addition, the surface treatment should be carried out before method step (c) is carried out. For example, the surface treatment or smoothening can be carried out using a smoothing and/or grinding roller or the like. The surface treatment, in particular surface smoothing, can be repeated, if necessary, until the desired surface property or smoothness is achieved. According to the invention, processing of at least one edge of the plastic strand and/or the edge coating can also be carried out, for example in the form of edge smoothing and/or edge rounding. The edge processing can be carried out before or after carrying out method step (c), preferably before carrying out method step (c). The surface or edge processing can be performed in particular on the cooled or in the non-flowable or solid (solidified) or at least partially cured thermoplastic plastic strand or the related edge coating.

In addition, the following can also be specified with regard to method step (c) in particular: Thus, according to the invention, in particular in method step (c), the application of the printing can be effected or carried out on the side of the thermoplastic plastic strand and/or the edge coating facing away from the plate-shaped substrate or the support in particular.

The printing according to method step (c) is carried out in particular in a solid (solidified) and/or non-hot-adhesive and/or at least partially cured state of the thermoplastic plastic strand and/or the edge coating. The thermoplastic plastic strand or the edge coating is thus present in a solid (solidified) and/or non-hot-adhesive and/or at least partially cured state during printing.

In particular, in method step (c), the application of the printing can be carried out using at least one printing and/or ink application apparatus (C). In this context, the substrate with the thermoplastic plastic strand and/or the edge coating can be guided along and/or past the printing and/or ink application apparatus (C) preferably with a uniform and/or linear and/or unidirectional movement. The printing and/or ink application apparatus (C) can comprise at least one printing and/or ink application device, in particular a plurality of printing and/or ink application devices. In this respect, in the case of use of a multi-color system, a respective printing or application device can be used for applying a respective or individual color.

According to the invention, in particular in method step (c), the application of the printing can be carried out in a dot-shaped form and/or in a screen-shaped form.

With regard to the method according to the invention, in particular in method step (c), the application of the printing can be carried out using ink jet printing or laser printing, in particular ink jet printing. According to a particularly preferred embodiment of the invention, the printing in method step (c) is thus carried out using inkjet printing.

In accordance with the invention, it is provided in particular that, in particular in method step (c), the application of the printing is carried out without the use of static or unchangeable printing forms.

By the use of inkjet or laser printing technology, preferably inkjet printing technology, a multitude of different (print) motifs can be realized according to the invention, as it were within the framework of a dynamic print image generation, which moreover can be adapted to a high degree (for example the decor design of the flat side of the substrate) and in this respect can also be individualized.

According to the invention, the application of the printing is carried out in particular by using at least one printing ink which can be applied preferably using ink jet printing and/or laser printing, in particular ink jet printing. According to the invention, in particular a UV-curable or UV-dryable printing ink is used. This ensures durable and resistant printing. In addition, low layer thicknesses can be set with regard to the printing. Such colors also comprise a high level of adhesion on the substrate, in the form of the thermoplastic plastic strand or the edge coating. The aforementioned colors also ensure, in the context of the printing technique used, preferably in the form of inkjet printing, a high degree of individuality and adaptability of the applied printed images or motifs.

According to the invention, it may be provided in this context in particular that the printing ink is dried and/or UV-cured (UV-dried) after its application and/or application onto the thermoplastic plastic strand or the edge coating in particular using at least one drying or UV-curing device.

According to the invention, it is particularly advantageous if the printing is carried out using a so-called multicolor system. According to the invention, in particular in method step (c), the application of the printing can thus be carried out in particular by multicolor printing or by using a plurality of printing inks which in particular differ from one another in color, in particular as defined above.

In accordance with the invention, it is provided in particular that the printing inks are applied or arranged in dot or screen form onto the thermoplastic plastic strand and/or the edge coating. As far as the resulting coloring or color mixture of the printing is concerned, this can in particular be brought about by superpositioning and/or juxtapositioning the printing inks. In this way, a large number of colors can be reproduced with a high degree of individualization of the printed motifs, and this with relatively low printing costs.

According to the invention, it may be provided in particular that the respective printing inks are applied successively or one after the other onto the thermoplastic plastic strand and/or onto the edge coating, in particular wherein the coloring (color mixing) is produced by superpositioning and/or juxtapositioning the printing inks on the thermoplastic plastic strand and/or on the edge coating.

According to the invention, it may be provided in particular that a respective printing ink is dried or UV-cured (UV-dried) in particular immediately after its application or before the application of a printing ink to be applied and/or applied subsequently. In this respect, corresponding drying devices or devices can be used, which can be connected downstream of a respective printing or ink application device, as still indicated below.

In accordance with a method embodiment according to the invention, it may be provided in particular that, in particular in method step (c), the application of the printing is carried out using a subtractive (printing) color system, in particular a CMYK (printing) color system (wherein C stands for cyan, M for magenta, Y for yellow (yellow) and K key (black). The CMYK color system which can preferably be used according to the present invention is thus based upon four components which can be used as image-forming components or for configuring a variety of colors.

Within the scope of the present invention, it is possible to proceed in particular in such a way that, in particular in method step (c), the thermoplastic plastic strand or the edge coating is first provided with a primer and/or base layer, in particular on the basis of and/or using at least one (top) ink, before applying the printing ink(s), in particular on the side facing away from the substrate. In this context, the primer and/or base coat should be applied onto the thermoplastic plastic strand and/or the edge coating at least substantially over the entire surface and/or at least substantially without interruption. In this context, the (top) coat color can be applied in particular using color jet printing (ink jet printing) and/or laser printing, in particular color jet printing (ink jet printing). Consequently, the application or applying can in particular be carried out using inkjet printing. In addition, the (covering) ink can be configured to be UV-curable or UV-dryable. As far as the (covering) ink is further concerned, it can in particular first be dried and/or UV-cured or UV-dried substantially immediately after its application or before application of the printing ink(s) to be applied and/or applied subsequently.

In principle, the (covering) ink can be a color of the same type as the printing ink(s) used according to the invention. In principle, spraying on or the like of the (covering) ink can also be considered.

In particular, a white (top) covering ink is used as the covering ink.

The primer or base layer using the (top) ink serves in particular to optically level out the underlying material in the form of the thermoplastic plastic strand or the related edge coating, so that this also improves the overall optical quality of the printing. In addition, the adhesion of the printing ink(s) can also be improved.

With regard to the multicolor printing technique preferably employed in accordance with the invention and the printing inks or color systems used in this respect, further reference can also be made to ISO 2846-1:2017.

Furthermore, according to the invention, it can also be provided that, in particular in method step (c), the thermoplastic plastic strand or the edge coating, after applying the printing ink(s), preferably after applying the (covering) ink and the printing ink(s), in particular on the side facing away from the substrate, is provided with a preferably transparent and/or translucent sealing or sealing layer, or that in particular as the last layer a corresponding finishing or sealing layer is applied onto the thermoplastic plastic strand or the edge coating. In this context, in particular at least one (clear) coating can be used.

In this context, the (clear) lacquer can be applied onto the thermoplastic plastic strand and/or the edge coating at least substantially over the entire surface or at least substantially without interruption.

Moreover, in this context, the (clear) lacquer can be dried and/or UV-cured or UV-dried in particular immediately after its application.

The (clear) lacquer can likewise be applied in particular by means of ink jet printing or laser printing preferably by means of ink jet printing. In principle, spraying on or the like is also a possibility, even if this is less preferred.

According to the invention, the final or sealing layer can basically be configured to be matt or glossy and/or structuring wherein the properties in this respect can be controlled, for example, by UV action, in particular during drying. According to the invention, the final or sealing layer can also be configured in a structured manner. In this context, in particular, a structuring (clear) coating can be carried out, for example using intermittent (clear) coating application or the like. In this case, the (clear) coating layers applied in each case can in particular be dried and/or UV-cured or UV-dried immediately after their respective application. According to the invention, the (clear) coating can in particular be dried and/or UV-cured (UV-dried) immediately after its application, as previously indicated.

The final or sealing layer serves in particular to further seal and protect the printing arranged underneath, wherein the optical properties can also be influenced accordingly. In addition, the final or sealing layer can in particular also serve to coat or seal the edge area of the narrow side or narrow surface of the substrate or the transition area between the narrow side with the applied coating and the flat side of the substrate. The final or sealing layer or the (clear) coating used for this purpose can likewise be applied according to a particular printing or ink application device, wherein a drying device, in particular a UV drying device, can be connected downstream thereof.

According to the invention, in particular in method step (c), the application of the printing can be carried out at least substantially along the entire length of the thermoplastic plastic strand or the edge coating and/or at least substantially edgelessly onto the plastic strand and/or the edge coating and/or at least substantially over the entire height of the thermoplastic plastic strand or the edge coating.

In addition, according to a preferred embodiment according to the invention, in particular in method step (c), the application of the printing can be controlled and/or carried out in an electronically or computer-based way, in particular computer-controlled, preferably using digital printing (synonymously also referred to as digital printing or direct digital printing or computer-to-print. In this respect, the print image to be created in the course of printing can be configured electronically based, in particular file-based or data stream-based. Thus, the print image or motif to be created on the plastic strand or edge coating can be transferred from an electronic file or data stream from a computer on the corresponding printing devices. On this basis, an individual configuration or adaptability of the print image to be created is possible, also on the basis of or starting from an individual electronic print image processing or the like.

In the following, detailed comments are made on the substrate which can be used within the scope of the method according to the invention, also with regard to further process aspects in this respect:

According to the invention, wood, wood substitutes, plastics, glass, or metals, preferably wood or wood substitutes, can be used as a plate-shaped substrate in particular. In particular, a wood substitute material based on plastics, or the like can also be used as a plate-shaped substrate. In this respect, corresponding material combinations can also be used, such as wood/plastic combinations or the like.

In the context of the present invention, the term wood substitute materials is understood in particular to mean wood fiber materials. Usually, wood fiber materials are those materials which contain wood fibers as a component, such as particle boards, MDF boards (medium-density fiber boards), OSB boards (oriented strand boards) or WPC boards (wood-plastic compounds boards). As previously indicated, a wood substitute material based on plastics can also be used as a plate-shaped substrate in particular. According to the invention, lightweight boards or the like can also be used as the in particular plate-shaped substrate.

Moreover, as far as the plate-shaped substrate is concerned, it may be provided in particular according to the invention that this is provided on at least one of its flat sides with a coating, in particular a film coating and/or a decorative coating, in particular based on plastics. In accordance with the invention, this is done in particular in such a way that the coating has already been applied and/or fixed on the substrate before method step (a) and/or (b) is carried out.

In general, the edge (narrow side, narrow surface) of the in particular plate-shaped substrate can comprise a height in the range from 1 mm to 200 mm, in particular in the range from 5 mm to 150 mm, preferably in the range from 10 mm to 100 mm, preferably in the range from 15 mm to 50 mm. Generally, the height of the edge corresponds or corresponds according to the thickness of the underlying plate-shaped substrate or the plate thickness. In addition, the plate-shaped substrate in particular may comprise a length in the range of 1 cm to 2,500 cm, in particular in the range of 10 cm to 1,000 cm, preferably in the range of 30 cm to 900 cm, preferably in the range of 50 cm to 800 cm.

In particular, the thermoplastic plastic strand, in particular the profiled plastic strand or the plastic film, can comprise heights (widths) and/or lengths according to this. According to the invention, the thermoplastic plastic strand, in particular the profiled plastic strand or the plastic film, can comprise a height in the range from 1 mm to 200 mm, in particular in the range from 5 mm to 150 mm, preferably in the range from 10 mm to 100 mm, preferably in the range from 15 mm to 50 mm. In addition, the thermoplastic plastic strand, in particular the profiled plastic strand or the plastic film, may comprise a length in the range from 1 cm to 2,500 cm, in particular in the range from 10 cm to 1,000 cm, preferably in the range from 30 cm to 900 cm, preferably in the range from 50 cm to 800 cm.

In this context, as far as the printing provided in accordance with method step (c) is concerned, it can in particular proceed as follows in accordance with the invention: At first, the dimensions, in particular the length and/or the height, of the surface of the in particular plate-shaped substrate to be equipped with the edge coating and/or the printing, preferably the edge (narrow side, narrow surface) of the plate-shaped substrate and/or of the carrier, can be recorded in particular electronically and/or in a computer-based way, and subsequently the producing of the thermoplastic plastic strand, in particular according to method step (a), and/or applying and/or fixing the thermoplastic plastic strand, in particular according to method step (b) and/or according to method step (a′), and/or applying of the print, in particular according to method step (c), is adapted to the determined dimensions or values, in particular independently of one another, and/or controlled as a function of the determined dimensions or values, in particular independently of one another, preferably in an electronically and/or computer-based way.

According to the invention, it can further be provided that first, in particular before the application of the printing and/or before method step (c), preferably at the start of the method, the optical formation, in particular the decoration, of the in particular plate-shaped substrate, preferably the flat side of the in particular plate-shaped substrate, is detected and/or analyzed, in particular electronically, and subsequently, in particular in method step (c), the printing is configured as a function of the optical formation, in particular the decoration, and/or adapted thereto. In particular, this can also be carried out in a computer-controlled manner within the scope of an automated process operation or a related process. In the context of the present invention, the design to be applied onto the thermoplastic plastic strand or the edge coating of the narrow side can be adapted exactly to the design, in particular of the flat side, of the underlying plate-shaped substrate, in particular in terms of location or point accuracy. This results in an optically particularly highly finished overall product. In particular, the design of the underlying substrate can be scanned, and the printing precisely adapted thereto, in particular using electronic data acquisition, processing and transmission, in particular in the form of a print file or a related data stream for controlling the printing or ink application apparatus (c).

In this way, for example, a high optical homogeneity or compatibility of the edge coating with the flat sides or flat surface of the substrate can be obtained.

In general, in method step (c), the application of the printing can be carried out at a speed (printing speed) in the range from 1 m/min to 300 m/min, in particular in the range from 10 m/min to 200 m/min, preferably in the range from 20 m/min to 100 m/min. In principle, according to the invention, there can also be a printing speed of more than 100 m/min, for example in the range from 100 m/min to 300 m/min. Moreover, in accordance with an embodiment according to the invention, the printing speed can in particular be in the range from 75 m/min to 150 m/min. In particular, the printing speed can also be synchronized with or apply to the previously mentioned generation speed and/or the applying or fixing speed, in particular in the case of continuous process operation or in the case of process operation in a joint process section or system line or in a joint process space. In particular, the printing speed can correspond to the generation speed and/or the application or fixing speed.

Within the scope of the present invention, it is provided in particular that the edge coating of the in particular plate-shaped substrate is formed exclusively by the thermoplastic plastic strand or that, apart from the thermoplastic plastic strand, no further edge coating, in particular no further edge tape, in particular no conventional edge tape, preferably no edge tape to be applied and/or fixed using an adhesive, is applied and/or fixed on the in particular plate-shaped substrate.

In particular, it can according to the invention be that the substrate obtainable and/or obtained according to the method, in particular at its edge coated according to the method, comprises no further edge coating, in particular no further edge tape, in particular no conventional edge tape, preferably no edge tape to be applied and/or fixed by means of an adhesive, apart from the thermoplastic plastic strand. According to the invention, the substrate coated according to the invention thus in particular comprises no edge band to be applied and/or fixed by means of an adhesive, for example based on PVC, ABS, PP, PMMA, PET, melamine, wood, or aluminum.

According to the invention, the thermoplastic plastic strand applied onto the substrate or its edge, or the edge coating itself, thus acts as an edge band, without the need for further, in particular conventional edge bands.

In the following, further and in addition to the above configurations, comments are now made on the thermoplastic plastic strand or on the material of the thermoplastic plastic strand, in particular with regard to the plastic polymers which can be used in this respect:

In accordance with the invention, it may be provided in particular that the thermoplastic plastic strand and/or the material of the thermoplastic plastic strand comprises or consists of at least one plastic polymer, in particular adhesive polymer, preferably heat-adhesive (hot melt) thermoplastic plastic polymer, preferably heat-adhesive (hot melt) adhesive polymer.

In this context, the plastic polymer may be selected from non-reactive and reactive systems, particularly non-reactive and reactive adhesives.

Further, in this context, the plastic polymer may be selected from homopolymers and copolymers and mixtures and combinations thereof.

Furthermore, in this context, the plastic polymer may be selected from the group consisting of polyolefins, polyamides, polyacrylates, polyesters, in particular polylactide, polyurethanes, ethylene-vinyl acetate copolymers, ethylene-acrylate copolymers, and mixtures and combinations thereof.

According to an embodiment according to the invention, the plastic polymer may comprise or consist of a hot melt adhesive (hot melt adhesive polymer), in particular a thermoplastic hot melt adhesive.

In accordance with the invention, it may be provided in particular that the thermoplastic plastic strand or the material of the thermoplastic plastic strand comprises or consists of at least one hot melt adhesive (hot melt adhesive polymer), in particular thermoplastic hot melt adhesive, preferably reactive or non-reactive hot melt adhesive. In this context, the hot melt adhesive may be a thermoplastic and/or single-component or two-component hot melt adhesive. For example, the hot melt adhesive may be a reactive one-component or reactive two-component hot melt adhesive, in particular a thermoplastic hot melt adhesive.

In particular, it may be provided according to the invention that the thermoplastic plastic strand and/or the material of the thermoplastic plastic strand comprises the plastic polymer, in particular adhesive polymer, preferably heat-adhesive (hot melt) thermoplastic plastic polymer, preferably heat-adhesive (hot melt) adhesive polymer, in an amount in the range from 1 wt. % to % to 100 wt. %, in particular in the range from 5 wt. % to 100 wt. %, preferably in the range from 7.5 wt. % to 100 wt. %, more preferably in the range from 10 wt. % to 100 wt. %, based on the thermoplastic plastic strand and/or the material of the thermoplastic plastic strand.

In this context, the thermoplastic plastic strand and/or the material of the thermoplastic plastic strand may comprise the hotmelt adhesive, in particular thermoplastic hotmelt adhesive, in an amount in the range from 1 wt. % to 100 wt. %, in particular in the range from 5 wt. % to 100 wt. %, preferably in the range from 7.5 wt. % to 100 wt. %, particularly preferably in the range from 10 wt. % to 100 wt. %, based on the thermoplastic plastic strand and/or the material of the thermoplastic plastic strand.

According to one embodiment of the invention, the hot melt adhesive may be a reactive hot melt adhesive. In this context, it may be equally provided according to the invention that the reactive hot melt adhesive is a moisture-crosslinking, heat-crosslinking and/or radiation-crosslinking hot melt adhesive, in particular a moisture-crosslinking hot melt adhesive.

In particular, the reactive hot melt adhesive may comprise chemically reactive groups, in particular wherein the chemically reactive groups are selected from isocyanate groups, silane groups, epoxy groups, urethane groups and reactive double or multiple bonds (in particular C—C double or multiple bonds) as well as combinations thereof, preferably isocyanate groups and silane groups, and/or in particular wherein the chemically reactive groups are terminal.

According to the invention, it may also be provided that the reactive hotmelt adhesive is selected from the group of (i) reactive, in particular moisture-crosslinking polyurethanes (PUR), preferably polyurethanes functionalized with isocyanate groups and/or containing isocyanate groups, preferably isocyanate-terminated polyurethanes; (ii) reactive, in particular moisture-crosslinking polyolefins (POR), preferably silane-group-functionalized and/or silane-group-containing polyolefins, preferably silane-group-grafted polyolefins; (iii) reactive, in particular radiation-crosslinking, preferably UV-crosslinking poly(meth)acrylates, preferably urethane-group-functionalized and/or urethane-group-containing poly(meth)acrylates; and combinations thereof, in particular preferably from the group consisting of (i) reactive, in particular moisture-crosslinking polyurethanes (PUR), preferably isocyanate-group-functionalized and/or isocyanate-group-containing polyurethanes, preferably isocyanate-terminated polyurethanes, and combinations thereof.

In addition, the hot melt adhesive may be a non-reactive hot melt adhesive, in particular a thermoplastic non-reactive hot melt adhesive.

In this context, the non-reactive hot melt adhesive may be selected from the group consisting of (i) ethylene vinyl acetates (EVA polymers); (ii) (meth-) acrylates; (iii) polyolefins (PO), in particular polyethylenes (PE), polypropylenes (PP) and atactic polyolefins (APAO); (iv) polyurethanes (PU); (v) polyamides (PA); (vi) polyesters (PES); (vii) ethylene acrylates; and combinations thereof, more preferably from the group of (i) ethylene vinyl acetates (EVA polymers); (ii) (meth)acrylates; (iii) polyolefins (PO); and combinations thereof.

In accordance with the invention, it may be provided in particular that the thermoplastic plastic strand and/or the material of the thermoplastic plastic strand also contains at least one further ingredient, preferably selected from the group consisting of antioxidants, catalysts, resins, waxes, fillers, wetting agents, rheology modifiers, stabilizers, flame retardants, dyes, lubricants, plasticizers, and mixtures thereof. In this way, the properties of the thermoplastic plastic strand can be further set or tailored, for example with regard to its rheology or its properties in the solid or cured state or the like.

According to the invention, it may be provided in principle and according to a first embodiment that the thermoplastic plastic strand and/or the material of the thermoplastic plastic strand contains at least one inorganic and/or organic filler. In this respect, the filler may be selected, for example, from the group of inorganic oxides, silicates, carbonates, sulfates, hydroxides and mixtures and combinations thereof, preferably from the group of aluminum oxides, silicon dioxide, barium sulfate, calcium carbonate, alkali metal oxides and alkaline earth metal oxides, titanium oxides, iron oxides and mixtures and combinations thereof. In addition, the thermoplastic plastic strand or the material of the thermoplastic plastic strand may contain the filler in an amount of at most 20% by weight, in particular at most 10% by weight, preferably at most 5% by weight, even more preferably at most 2% by weight, very preferably at most 1% by weight, based on the thermoplastic plastic strand and/or the material of the thermoplastic plastic strand.

In general, the filler can comprise an average particle size, in particular an average particle diameter, preferably an average particle diameter D50, in the range from 3 μm to 20 μm, preferably in the range from 3.5 μm to 15 μm, more preferably in the range from 4 μm to 10 μm, most preferably in the range from 5 μm to 10 μm. In this respect, methods known per se to the skilled person for determining the particle size can be used, such as, for example, methods or determination methods based on light scattering or laser diffraction, X-ray diffraction or microscopic methods or the like.

However, according to a further and in accordance with the present invention more preferably embodiment, it can also be provided that the thermoplastic plastic strand or the material of the thermoplastic plastic strand contains at least essentially no filler, in particular at least essentially no inorganic filler, and/or wherein the thermoplastic plastic strand and/or the material of the thermoplastic plastic strand is free from fillers, in particular free from inorganic filler.

In particular, the present invention has succeeded in dispensing with the use of fillers on the thermoplastic plastic strand and/or the material on which it is based. This also results in processing-specific advantages, for example with regard to the prevention of clogging of nozzle devices or the like used in the course of producing or applying or fixing. In addition, the elimination of fillers is also associated with improved overall material properties.

In general, the thermoplastic strand and/or the material of the thermoplastic strand, in particular the plastic polymer and/or the hot melt adhesive, can be characterized by at least one of the following properties:
a processing temperature in the range from 60° C. to 300° C., in particular in the range from 70° C. to 280° C., preferably in the range from 80° C. to 250° C.; and/or
a softening range and/or a softening temperature in the range from 30° C. to 200° C., in particular in the range from 40° C. to 180° C., preferably in the range from 50° C. to 150° C., in particular determined in accordance with DIN EN ISO 306:2014 (wherein the determination can alternatively also be performed with a Kofler heating bench)
(the softening temperature defines in particular the temperature at which thermoplastic materials can be permanently deformed, wherein in this respect there may also be corresponding softening ranges);
and/or
a Shore hardness, in particular a Shore hardness A, in particular determined at 20° C., in the range from 20 to 100, in particular in the range from 25 to 95, preferably in the range from 30 to 90, in particular determined in accordance with DIN EN ISO 868:2003
(the Shore hardness characterizes in particular the deformation behavior of a material. To measure the Shore hardness, in particular the Shore hardness A, it is possible in particular to proceed in such a way that a 1 kg test weight is pressed on the material for 15 seconds, wherein the test weight comprises a flat tip with a diameter of 0.79 mm and an opening angle of 35°; the penetration depth is measured on a scale from 0 to 100 Shore, wherein a penetration depth of 2.5 mm corresponds to a Shore value of 0 and a penetration depth of 0 mm corresponds to a Shore value of 100; the Shore hardness refers in particular onto the solid or at least partially cured state of the thermoplastic plastic strand or the resulting edge coating; in particular, the indentation hardness can be determined using a durometer);
and/or
a glass transition temperature Tg in the range from −50° C. to 0° C., in particular in the range from −40° C. to −5° C., preferably in the range from −25° C. to −10° C., in particular determined in accordance with DIN EN ISO 11357-2:2020
(the glass transition temperature can be measured in particular using differential scanning calorimetry (DSC), wherein DSC is a thermoanalytical analysis in which the difference in the amount of heat required to raise the temperature of a sample and a reference is measured as a function of temperature);
and/or
a melt flow index in the range from 1 g per 10 min to 200 g per 10 min, in particular in the range from 5 g per 10 min to 150 g per 10 min, preferably in the range from 10 g per 10 min to 100 g per 10 min, in particular determined according to DIN EN ISO 1133-1:2012;
(the melt flow index characterizes the flow behavior of thermoplastics under specific pressure and temperature conditions, wherein the melt mass flow rate and the melt volume flow rate can be determined in this context; the melt flow index is a measure of the viscosity of the corresponding melt; the melt flow index is measured in particular using a capillary rheometer; the material is melted in a cylinder and forced through a defined capillary (nozzle) at a defined pressure (contact load) at a defined temperature; in the process, the emerging volume or the exiting mass is determined as a function of time (typically per 10 min));
and/or
a density, in particular determined at 20° C., in the range from 0.7 to 2 g/cm³, in particular in the range from 0.8 to 1.9 g/cm³, preferably in the range from 0.85 to 1.8 g/cm³, in particular determined according to DIN EN ISO 2811-1:2016; and/or
a viscosity, in particular determined in the range from 120° C. to 200° C., in the range from 2,000 to 200,000 mPas, in particular in the range from 2,200 to 190,000 mPas, preferably in the range from 2,500 to 180,000 mPas, in particular determined in accordance with DIN EN ISO 2555:2018
(viscosity is in particular a measure of viscosity and can be measured in the context of the present invention, in particular with a rotational viscometer using the so-called Brookfield method; in this context, viscosity is determined by means of the deflection of a torsion element; for this purpose, a spindle is immersed in the sample and rotated at a predetermined rotational speed, wherein the force required to keep the rotational speed constant is measured; in this context, the force is a measure of dynamic viscosity);
and/or
an open waiting time, determined in particular at a temperature in the range from 170° C. to 200° C. and at a film thickness in the range from 90 to 200 μm, in the range from 1 to 20 seconds, in particular in the range from 1 to 15 seconds, preferably in the range from 1 to 12 seconds
(the open waiting time determines in particular the time between application and bonding or joining of the bonded parts; this time is variable and depends on the formulation, the material of the parts to be bonded and the temperature conditions of the environment and parts; the open waiting time can be determined in particular in accordance with DIN EN 923);
and/or
a reaction time, in particular in the case of reactive materials of the thermoplastic plastic strand, in particular reactive plastic polymers and/or reactive hotmelt adhesives, in the range from 0.1 to 20 days, in particular in the range from 0.5 to 18 days, preferably in the range from 1 to 17 days, determined in particular using infrared spectroscopy, in particular ATR infrared spectroscopy (Attenuated Total Reflection)
(the reaction time is a special property in particular of reactive adhesives, wherein it determines the time required to (chemically) cure the adhesive).

According to the invention, the plastic strand or the edge coating, in particular the plastic polymer and/or the hotmelt adhesive, in the non-flowable or solid (solidified) and/or at least partially cured state, can also be characterized by at least one of the following properties:
a peel strength (90° peel test or T-peel test) in the range from 10 to 200 N/cm, in particular in the range from 30 to 175 N/cm, preferably in the range from 50 to 150 N/cm, in particular determined in accordance with DIN EN 1464:2010
(the 90° peel adhesion test is used in particular to determine the force required to separate two components bonded by an adhesive. In the 90° peel adhesion test, a constant 90° angle is maintained while the two bonded components are pulled apart; the force required to release the bonded components from each other is measured);
and/or
a shear strength (shear value) in the range from 1 N/mm² to 40 N/mm², in particular in the range from 2 N/mm² to 35 N/mm², preferably in the range from 5 N/mm² to 30 N/mm², in particular determined in accordance with DIN EN 1465:2009
(shear strength (shear value) is the ability of a material to resist forces that can cause the internal structure of the material to slip against itself, wherein adhesives typically tend to have high shear strength; shear strength is the resistance that a solid presents to tangential shear forces; thus, it is the load that an article can withstand in a direction parallel to the surface of the material as opposed to a direction perpendicular to the surface);
and/or
a loss range (tangent delta or tan 6), in particular determined at a temperature in the range from −20° C. to 150° C. and at a frequency of 1 Hz, in the range from 0.01 to 100, in particular in the range from 0.05 to 90, preferably in the range from 0.1 to 80
(the loss range indicates in particular the ratio between the loss modulus and the storage modulus; the higher the loss factor, the more the behavior of a sample approaches that of an ideal viscous fluid with Newtonian flow behavior, or the more the behavior of a sample corresponds to that of an ideal elastic solid; in general, an ideal elastic body comprises a value of 0 and an ideal viscous body comprises an infinite value);
and/or
a storage modulus (G′), determined at a temperature of 25° C., in the range from 1·10⁵ Pa to 1·10⁹ Pa, in particular in the range from 1·10⁵ Pa to 1·10⁸ Pa, preferably in the range from 1·10⁶ Pa to 1·10⁸ Pa, in particular determined according to DIN EN ISO 6721-1:2019; and/or
a storage modulus (G′), determined at a temperature of 150° C., in the range from 1 Pa to 1·10³ Pa, in particular in the range from 10 Pa to 1·10³ Pa, preferably in the range from 10 Pa to 1·10² Pa, in particular determined according to DIN EN ISO 6721-1:2019; and/or
a loss modulus (G″), determined at a temperature of 25° C., in the range from 1·10³ Pa to 1·10⁹ Pa, in particular in the range from 1·10⁴ Pa to 1·10⁹ Pa, preferably in the range from 1·10⁵ Pa to 1·10⁸ Pa, in particular determined according to DIN EN ISO 6721-1:2019; and/or
a loss modulus (G″), determined at a temperature of 150° C., in the range from 1 Pa to 1·10⁴ Pa, in particular in the range from 10 Pa to 1·10⁴ Pa, preferably in the range from 10 Pa to 1·10³ Pa, in particular determined according to DIN EN ISO 6721-1:2019; and/or
a modulus of elasticity (stress-strain), determined at a temperature of 25° C., in the range from 1 N/mm² to 5,000 N/mm², in particular in the range from 100 N/mm² to 4,000 N/mm², preferably in the range from 1,000 N/mm² to 2,500 N/mm², in particular determined in accordance with DIN EN ISO 527-1:2019 and/or DIN EN ISO 527-2:2012.

According to the invention, particularly high moduli of elasticity can be achieved in particular with the use of plastic polymers in the form of polyesters, in particular in the range from 1,000 N/mm² to 5.00 N/mm².

Furthermore, according to the invention, it can in particular be that the composite is characterized by at least one of the following properties:
a water resistance in the range from 3 to 5, in particular in the range from 4 to 5, in particular determined according to Ikea TM 0002
(the water resistance is evaluated as a function of the visually detectable or visible manifestation of the swelling caused by water, in particular in the edge area or connection area (joint) between the substrate or narrow edge of the substrate and the edge coating applied or fixed thereto, with a rating of 1 to 5, wherein the value 5 relates to the best properties in this respect (i.e. in particular no swelling or a swelling of less than 0.05 mm));
and/or
a heat resistance in the range from 3 to 5, in particular in the range from 4 to 5, in particular determined according to Ikea TM 0002
(the heat resistance is evaluated as a function of the visually detectable or visible manifestation of the changes occurring due to the action of heat, in particular in the edge area or connection area (joint) between the substrate or narrow edge of the substrate and the edge coating applied or fixed thereto, with a rating of 1 to 5, wherein the value 5 relates to the best properties in this respect (i.e. in particular no changes caused by the action of heat));
and/or
a resistance to humid climatic conditions, in particular determined in accordance with AMK Module 2 Merkblatt 005, April 2015 at least substantially without any visually detectable and/or visible change in the composite and/or the edge coating
(the resistance to humid climatic conditions refers to the visually detectable or visible changes, in particular in the edge area or connection area (joint) between the substrate or narrow edge of the substrate and the edge coating applied or fixed thereto, wherein, according to the invention, as stated above, there is at least essentially no change in the composite and/or the edge coating under the test conditions present);
and/or
an alternating climate resistance, in particular determined according to AMK module 3 data sheet 005, April 2015, at least substantially without visually detectable and/or visible change of the composite and/or the edge coating;
(the alternating climate resistance refers to the visually detectable or visible changes, in particular in the edge area or connection area (joint) between the substrate or narrow edge of the substrate and the edge coating applied or fixed thereto, wherein, according to the invention, as stated above, there is at least essentially no change in the composite and/or the edge coating under the test conditions present);
and/or
a resistance to water vapor, in particular determined in accordance with AMK module 1 data sheet 005, April 2015, at least substantially without a visually detectable and/or visible change in the composite and/or the edge coating;
(the water vapor resistance refers to the visually detectable or visible changes in particular in the edge area or connection area (joint) between the substrate or narrow edge of the substrate and the edge coating applied or fixed thereto, wherein according to the invention, as previously stated, there is at least essentially no change in the composite and/or the edge coating under the present test conditions);
and/or
a UV resistance according to gray scale in the range from 3 to 5, in particular in the range from 4 to 5, preferably 5, and/or according to blue scale (wool scale) in the range from 6 to 8, in particular in the range from 7 to 8, preferably 8, in particular determined according to DIN EN ISO 4892-2:2013 and/or according to DIN EN 15187:2006;
(for UV resistance, in particular, a classification according to gray scale and blue scale (wool scale) can be performed after exposure; the higher the determined value, the less color changes are visible; the classification 5 according to gray scale is the highest rating and means no visible color change; the blue scale gives the possibility to express the resistance in years, wherein the value 8 (maximum value) corresponds to 1.5 years).

As far as the method according to the invention is further concerned, it can in particular be according to the invention in such a way that the plate-shaped substrate for producing and/or applying and/or fixing the thermoplastic plastic strand, in particular according to method step (a) and/or (b), is first passed along the producing apparatus (A) and/or along the applying and/or fixing apparatus (B), in particular along the combined producing and applying and/or fixing apparatus, and then is guided along and/or past the printing and/or ink application apparatus (C) for applying the printing onto the thermoplastic plastic strand and/or the edge coating, in particular in accordance with method step (c).

In this context, according to a first embodiment of the invention, it may be provided, on the one hand, that the apparatuses (A, B, C) are arranged in a joint processing section or system line and/or in a joint processing space (system space). On the other hand, however, it can also be provided in accordance with the present invention that the apparatuses (A, B, C), in particular the producing apparatus (A) and/or the applying and/or fixing apparatus (B), preferably the combined producing and applying or fixing apparatus, on the one hand, and the printing and/or ink application apparatus (C) on the other hand, are arranged in separate process sections or system lines and/or in separate process spaces (system spaces) from each other.

In accordance with a further embodiment of the present invention, however, it may also be provided that the carrier, in particular in accordance with method step (a) and/or (a′), first passes along the producing apparatus (A) and/or along a carrier application and/or fixing apparatus, in particular along a combined producing and carrier application and/or fixing apparatus. and/or fixing apparatus, in particular a combined producing and carrier applying or fixing apparatus, and the thermoplastic plastic strand produced is applied and/or fixed to the carrier and is subsequently guided along and/or past the printing and/or ink application apparatus (C) for the application of the printing to the thermoplastic plastic strand, in particular in accordance with method step (c), wherein subsequently the carrier is removed and the plate-shaped substrate is guided along and/or past the applying and/or fixing apparatus (B) for applying and/or fixing the thermoplastic plastic strand on the substrate, in particular according to method step (b).

As far as the aforementioned two embodiments are concerned, however, it can in principle also be in such a way that the substrate is fixed, so to speak, and the corresponding apparatuses are guided along and/or past the substrate, in particular along the edge of the substrate.

According to the invention, the apparatuses (A, B, C) can be arranged in a joint process section or system line and/or in a joint process space (process space). In contrast, the apparatuses (A, B, C), in particular the producing apparatus (A) and the printing and/or ink application apparatus (C), on the one hand, and the applying and/or fixing apparatus (B), on the other hand, or, in particular, the producing apparatus (A), on the one hand, and the printing and/or ink application apparatus (C) and the applying and/or fixing apparatus (B), on the other hand, can be arranged in separate process sections or system lines and/or in separate process spaces (process spaces) from each other.

For further relevant configurations regarding the method according to the present aspect, reference can also be made to the configurations regarding the further aspects according to the present invention, which apply accordingly.

A further subject-matter of the present invention—according to a second aspect of the present invention—is furthermore the system (plant), in particular for carrying out a method for edge coating (narrow side coating, narrow surface coating) of an in particular plate-shaped substrate (material substrate), preferably a plate-shaped wood and/or furniture part, preferably for carrying out a method for applying an edge coating to at least one edge (narrow side, narrow surface) of a plate-shaped substrate, preferably a plate-shaped wood and/or furniture part, preferably for carrying out a method according to one of the preceding claims, wherein the system comprises the following components and/or apparatuses:
(A) at least one producing apparatus (A), in particular for producing a heat-adhesive (hot-adhesive) thermoplastic plastic strand, in particular plastic profile strand or plastic film, preferably in the form of an edging tape, and/or for carrying out method step (a);
(B) at least one application and/or fixing apparatus (B), in particular for applying and/or fixing the thermoplastic plastic strand, in particular plastic profile strand or plastic film, to the in particular plate-shaped substrate, in particular to at least one edge (narrow side, narrow surface) of the plate-shaped substrate, in particular in such a way that an edge coating (narrow side coating, narrow surface coating) of the in particular plate-shaped substrate results and/or that a composite of the in particular plate-shaped substrate with the edge coating applied and/or fixed thereto results, and/or for carrying out method step (b);
(C) at least one printing and/or ink application apparatus (C), in particular for applying a printing onto the thermoplastic plastic strand, in particular plastic profile strand or plastic film, and/or onto the edge coating, and/or for carrying out method step (c).

According to the invention, the producing apparatus (A) and the application and/or fixing apparatus (B) may be combined or configured as a combined producing and application and/or fixing apparatus, as also previously indicated. According to the invention, the application and/or fixing apparatus (B) may be configured as an application and/or fixing and/or forming apparatus. Moreover, the combined producing and applying and/or fixing apparatus may be configured as a combined producing and applying and fixing and shaping apparatus.

According to a first embodiment of the invention, it may be provided that the producing apparatus (A), the application and/or fixing apparatus (B), in particular the combined producing and application and/or fixing apparatus, and the printing and/or ink application apparatus (C) are connected and/or arranged downstream and/or in the process direction preferably directly one behind the other and/or one after the other in the order of previously specified.

According to a further embodiment of the invention, however, it can also be provided that the producing apparatus (A), the printing and/or ink application apparatus (C) and the applying and/or fixing apparatus (B) are connected and/or arranged in the process direction in the order specified previously downstream and/or in the process direction preferably directly one behind the other and/or one after the other. Such an arrangement of the apparatuses is present in particular in the case where the thermoplastic plastic strand is applied onto a substrate as part of an intermediate step (cf. also the above configuration for method step (a′)).

According to the invention, it can generally be provided that the producing apparatus (A), the application and/or fixing apparatus (B), in particular the combined producing and application or fixing apparatus, and the printing and/or ink application apparatus (C) are arranged in a joint process section or system line and/or in a joint process space (process space), or else that the producing apparatus (A), the application and/or fixing apparatus (B), in particular the combined producing and application or fixing apparatus (AB), and the printing and/or ink application apparatus (C) are arranged in a joint process section or system line and/or in a joint process space (system space). fixing apparatus (AB), and the printing and/or ink application apparatus (C) are in particular arranged at least partially in process sections or system lines which are different from one another and/or separate from one another and/or in process spaces (system spaces) which are different from one another and/or separate from one another.

According to the invention, it can also be provided that the producing apparatus (A) and the application and/or fixing apparatus (B), on the one hand, and the printing and/or ink application apparatus (C), on the other hand, are each arranged in process sections or system lines separate from one another and/or in process spaces (process spaces) separate from one another, or else that the producing apparatus (A) and the printing and/or ink application apparatus (C), on the one hand, and the application and/or fixing apparatus (B), on the other hand, are each arranged in process sections or system lines separate from one another and/or in process spaces (process spaces) separate from one another.

According to the invention, it may be provided that the printing and/or ink application apparatus (C) comprises at least one printing and/or ink application device, in particular a plurality of printing and/or ink application devices. In this respect, the printing and/or ink application devices can be connected or arranged one behind the other and/or one after the other in the downstream process direction and/or in the process direction.

In addition, it may be provided in accordance with the invention that the printing and/or ink application apparatus (C) comprises at least one drying device, in particular a plurality of drying devices, in particular for drying and/or curing, in particular UV curing, a respective previously applied printing ink. In this context, it can also be provided that the respective drying device is arranged downstream of a respective printing and/or ink application device in the process direction or is arranged downstream thereof in the process direction.

In addition, it may also be within the scope of the present invention in particular in such a way that the printing and/or ink application apparatus (C) comprises at least one coating application device, in particular for applying a preferably transparent and/or translucent finishing and/or sealing layer, in particular based on and/or using at least one (clear) coating. In this respect, the varnish application device can be arranged downstream of the printing and/or ink application devices in the process direction and/or downstream thereof in the process direction. Similarly, it may be provided in accordance with the invention that at least one (further) drying device is arranged downstream in the process direction or downstream in the process direction from the coating application device, in particular for drying and/or curing and/or setting the gloss and/or mattness of the applied (clear) coating and/or for producing a structured coating surface and/or structured coating surface.

In addition, it may be provided in accordance with the invention that the system comprises at least one surface processing apparatus, in particular for processing preferably smoothing the surface of the thermoplastic plastic strand and/or the edge coating, in particular wherein the surface processing apparatus is configured as a smoothing grinding milling calibrating cutting and/or polishing apparatus and/or, in particular, wherein the surface processing apparatus is arranged upstream of the printing and/or ink application apparatus (C) in the process direction and/or is connected upstream or upstream of the latter in the process direction.

The surface processing of the thermoplastic plastic strand or the edge coating is generally carried out prior to the application of the print, which is also reflected in the arrangement of the apparatuses in this respect in the system according to the invention.

As previously also indicated in the context of the method according to the invention, the heat-adhesive thermoplastic plastic strand or the edge coating comprises at least one plastic polymer and preferably at least one thermoplastic plastic polymer or at least one hot-melt adhesive. In this context, it is preferred according to the invention that the thermoplastic plastic strand or the edge coating, in particular at the time of and/or during carrying out method steps (a) and/or (a′) and/or (b), in particular (a) and (b) on the one hand or (a), (a′) and (b) on the other hand, preferably at the time of and/or during carrying out the entire method, comprises at least essentially no non-thermoplastic plastic polymers and, in particular, no non-thermoplastic plastic polymers arranged in a layer or the like. This makes it possible, in the course of producing or applying or fixing, to completely convert the underlying thermoplastic polymer into a flowable or heat-adhesive state. Thus, in accordance with the invention, it may be provided in particular that the thermoplastic plastic strand or the edge coating is at least substantially free of non-thermoplastic plastic polymers.

In particular, it may be provided according to the invention that the thermoplastic plastic strand provided and/or used in method steps (a) and/or (a′) and/or (b), in particular (a) and (b) on the one hand or (a), (a′) and (b) on the other hand, is at least substantially free of non-thermoplastic plastic polymers. In addition, it may be provided according to the invention that in the resulting (end) product and/or after carrying out the method according to the invention, the thermoplastic plastic strand or the edge coating is at least substantially free of non-thermoplastic plastic polymers.

For further relevant configurations regarding the system according to the invention and/or the plant according to the invention, reference can also be made to the configurations regarding the further aspects according to the invention, which are applicable according to the present.

A further subject-matter of the present invention—according to a third aspect of the invention—is the plate-shaped substrate (material substrate), in particular plate-shaped wood and/or furniture part, wherein the substrate comprises on at least one edge (narrow side, narrow surface) a thermoplastic strand, in particular a plastic profile strand or plastic film, applied and/or fixed thereto and in particular configuring an edge coating, wherein the substrate is obtainable and/or obtained by a method according to one of the preceding claims.

In the context of the present aspect, the present invention also relates to a plate-shaped substrate (material substrate), in particular plate-shaped wood and/or furniture part, wherein the substrate comprises on at least one edge (narrow side, narrow surface) a thermoplastic plastic strand, in particular plastic profile strand or plastic film, applied and/or fixed thereto and in particular configuring an edge coating, in particular a substrate as defined above,
wherein the thermoplastic plastic strand and/or the edge coating comprises at least substantially no fillers and/or wherein the thermoplastic plastic strand and/or the edge coating is at least substantially free of fillers.

In accordance with the present aspect, the present invention also relates to a plate-shaped substrate (material substrate), in particular plate-shaped wood and/or furniture part, wherein the substrate comprises on at least one edge (narrow side, narrow surface) a thermoplastic strand, in particular a plastic profile strand or plastic film, applied and/or fixed thereto and in particular configuring an edge coating, in particular a substrate as defined above,
wherein the plate-shaped substrate comprises and/or is configured as a composite with the edge coating applied and/or fixed to the substrate, wherein the composite is characterized by at least one of the following properties:
   a water resistance in the range from 3 to 5, in particular in the range from 4 to 5, in particular determined according to Ikea TM 0002; and/or
   a heat resistance in the range from 3 to 5, in particular in the range from 4 to 5, in particular determined according to Ikea TM 0002; and/or
   a wet-climate resistance, in particular determined in accordance with AMK Module 2 Merkblatt 005, April 2015, at least substantially without visually detectable and/or visible change in the composite and/or the edge coating; and/or
   an alternating climate resistance, in particular determined according to AMK module 3 data sheet 005, April 2015, at least substantially without visually detectable and/or visible change of the composite and/or the edge coating; and/or
   a resistance to water vapor, in particular determined in accordance with AMK module 1 data sheet 005, April 2015, at least substantially without visually detectable and/or visible change in the composite and/or the edge coating; and/or
   a UV resistance according to gray scale in the range from 3 to 5, in particular in the range from 4 to 5, preferably 5, and/or according to blue scale (wool scale) in the range from 6 to 8, in particular in the range from 7 to 8, preferably 8, in particular determined according to DIN EN ISO 4892-2:2013 and/or according to DIN EN 15187:2006.

As far as the plate-shaped substrate according to the invention is further concerned, it can be envisaged according to the invention that the edge coating of the plate-shaped substrate is formed exclusively by the thermoplastic plastic strand and/or wherein the thermoplastic plastic strand forms the only edge coating of the in particular plate-shaped substrate and/or wherein the in particular plate-shaped substrate comprises, apart from the thermoplastic plastic strand, no further edge tape, in particular no conventional edge tape, preferably no edge tape which can be applied and/or fixed by means of an adhesive.

In general, the thermoplastic plastic strand in the finished product, including the applied printing, can have a thickness in the range from 0.06 mm to 3.25 mm, in particular in the range from 0.085 mm to 2.25 mm, preferably in the range from 0, 125 mm to 1.7 mm, preferably in the range from 0.2 mm to 1.5 mm, more preferably in the range from 0.22 mm to 1.2 mm, most preferably in the range from 0.25 mm to 1 mm, further preferably in the range from 0.3 mm to 0.9 mm.

In the following, the present invention will be explained in more detail with reference to figure representations of preferred embodiments. In the context of explaining these preferred embodiments of the present invention, which are, however, in no way limiting with respect to the present invention, further advantages, properties, aspects and features of the present invention will also be described.

In the figure illustrations it is shown in

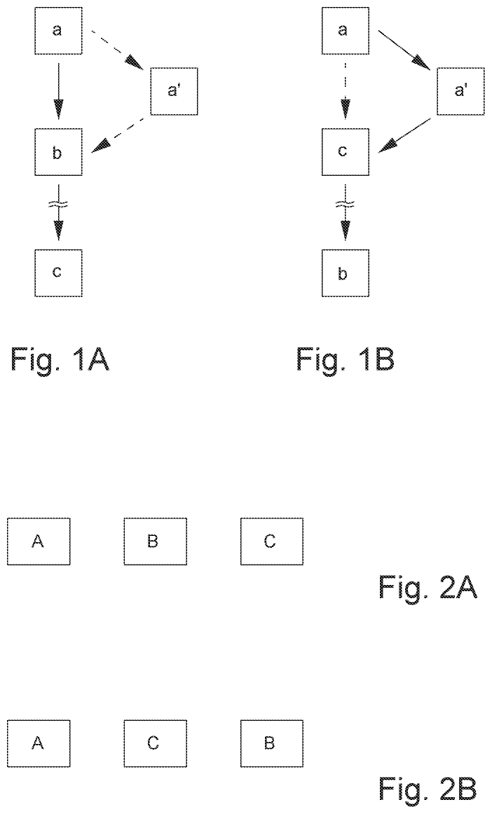

FIG. 1A a schematic representation of a process sequence according to the invention for edge coating according to a first embodiment;

FIG. 1B a schematic representation of a process sequence according to the invention for edge coating according to a further embodiment according to the invention;

FIG. 2A a schematic representation of the arrangement of various apparatuses for providing a system (plant) according to the invention in accordance with an embodiment according to the invention;

FIG. 2B a schematic representation of the arrangement of various apparatuses for providing a system (plant) according to the invention in accordance with a further embodiment according to the invention.

FIG. 1A shows a sequence of the method according to the invention for edge coating according to which a heat-adhesive or hot-adhesive thermoplastic plastic strand is first produced in accordance with method step (a), which in particular is applied and/or fixed directly afterwards in accordance with method step (b) on an in particular plate-shaped substrate, in particular on at least one edge of the plate-shaped substrate. After applying and/or fixing, the application of a printing onto the thermoplastic plastic strand or onto the edge coating is then carried out according to method step (c), if necessary with a time interruption or with an independent process operation or in a different process space with respect to the execution of method steps (a) and (b). FIG. 1A also shows a method sequence with the carrying out of an intermediate step in the form of method step (a′), according to which the thermoplastic plastic strand previously produced according to method step (a) is applied and/or fixed on a carrier before being applied and/or fixed on the plate-shaped substrate according to method step (b), wherein in this context storage and/or transport of the thermoplastic plastic strand applied on a carrier can be carried out for the purpose of subsequent applying and/or fixing on the in particular plate-shaped substrate.

FIG. 1B shows an alternative process sequence, according to which the heat-adhesive plastic strand produced in method step (a) is first applied and/or fixed on a carrier in accordance with the intermediate step or method step (a′), followed by the application of a printing in accordance with method step (c), wherein the method can also be interrupted or carried out discontinuously between method step (a′) and method step (c), in particular in different process spaces or the like. Subsequently, likewise if necessary after an interruption or discontinuously or in another process space, the printed thermoplastic plastic strand applied onto a carrier can be applied and/or fixed on a in particular plate-shaped substrate according to method step (b), in particular after removal of the carrier. FIG. 1B also shows an alternative embodiment, according to which the thermoplastic plastic strand produced in method step (a) is printed directly according to method step (c) without carrying out method step (a′).

Furthermore, FIG. 2A shows an arrangement corresponding to the process operation according to FIG. 1A of the apparatuses underlying a system according to the invention or a related system for carrying out the method according to the invention, according to which the system comprises a producing apparatus (A), an application or fixing apparatus (B) and a printing or ink application apparatus (C). The producing apparatus (A), the applying and/or fixing apparatus (B), and the printing and/or ink application apparatus (C) are connected or arranged in series downstream or in the process direction in the order specified previously, so that production of the heat-adhesive plastic strand is carried out first, followed by applying and/or fixing on the plate-shaped substrate, and again followed by application of a printing.

FIG. 2B shows an arrangement corresponding to the process operation according to FIG. 1B of the apparatuses underlying a system according to the invention for carrying out the method according to the invention or an installation relating thereto, wherein the producing apparatus (A), the printing or ink application apparatus (B) and the applying or fixing apparatus (C) are connected or arranged in series downstream or in the process direction in the order described above.

For further relevant configurations of the plate-shaped substrate according to the invention, reference can also be made to the configurations of the further aspects according to the invention, which apply accordingly here.

Furthermore, another subject-matter of the present invention—according to a further aspect of the present invention—is moreover the inventive Use of a heat-adhesive thermoplastic strand, in particular a plastic profile strand or plastic film, preferably in the form of an edge tape, for edge coating (narrow-side coating, narrow-surface coating) of a substrate, in particular a plate-shaped substrate (material substrate), preferably a plate-shaped wood and/or furniture part, in the previously defined method according to the invention.

For further relevant explanations regarding the use according to the present aspect, reference can also be made to the explanations regarding the further aspects according to the present invention, which apply accordingly.

Furthermore, another subject-matter of the present invention—according to a further aspect of the present invention—is furthermore the inventive use of a heat-adhesive (hot-adhesive) thermoplastic plastic strand, in particular plastic profile strand or plastic film, preferably in the form of an edge tape, for edge coating (narrow-side coating, narrow-surface coating) of an in particular plate-shaped substrate (material substrate), preferably a plate-shaped wood and/or furniture part, preferably for applying an edge coating to at least one edge (narrow side, narrow surface) of a plate-shaped substrate, preferably a plate-shaped wood and/or furniture part wherein the thermoplastic strand is applied and/or fixed to the in particular plate-shaped substrate, in particular to at least one edge (narrow side, narrow surface) of the plate-shaped substrate, preferably applied and materially bonded and/or permanently fixed, in particular in such a way that an edge coating (narrow side coating, narrow surface coating) of the in particular plate-shaped substrate results and/or that a composite of the in particular plate-shaped substrate with the edge coating applied and/or fixed thereto results, and
wherein before or after applying and/or fixing the thermoplastic plastic strand, in particular plastic profile strand or plastic film, and/or the edge coating, a printing is applied onto the thermoplastic plastic strand, in particular plastic profile strand or plastic film, and/or onto the edge coating.

For further relevant explanations regarding the use according to the present aspect of the invention, reference may also be made to the explanations regarding the further aspects according to the present invention, which apply accordingly.

Further configurations, variations, modifications, special features and advantages of the present invention are readily apparent and realizable to those skilled in the art upon reading the description, without departing from the scope of the present invention.

The present invention will be further illustrated with reference to the following embodiments, which are in no way intended to limit the present invention.

### Working Examples

The method according to the invention is illustrated by the following examples.

### General Procedure

In a particular embodiment of the method according to the invention, a heat-adhesive (hot-melt) thermoplastic plastic strand, in particular a profiled plastic strand or plastic film, is first produced, preferably in the form of an edgeband, preferably using extrusion.

The produced heat-adhesive (hot-melt) thermoplastic plastic strand is applied on an in particular plate-shaped substrate, preferably on a plate-shaped wood or furniture part, and fixed and, if necessary, subsequently formatted, so that an edge coating (synonymously also referred to as narrow-side coating or narrow-surface coating) of the in particular plate-shaped substrate with the thermoplastic plastic strand results, or so that a composite of the in particular plate-shaped substrate with the edge coating applied and/or fixed thereto results.

If necessary or desired, post-processing, in particular homogenization, can then be carried out, for example using milling, smoothening, grinding, cutting and/or polishing.

In a next method step, a printing is applied onto the thermoplastic plastic strand, in particular plastic profile strand or plastic film, or onto the edge coating using digital printing.

### Alternative Procedure

According to an alternative particular embodiment of the method according to the invention, a heat-adhesive (hot-melt) thermoplastic plastic strand, in particular plastic profile strand or plastic film, is first produced, preferably in the form of an edgeband, preferably using extrusion.

In an intermediate step, the produced heat-adhesive (hot-melt) thermoplastic plastic strand is applied on a carrier and fixed, preferably applied and fixed in a removable or intermediate (i.e., non-permanent) manner.

If necessary or desired, post-processing, in particular homogenization, can then be carried out, for example using milling smoothening, grinding, cutting and/or polishing. Subsequently, the heat-adhesive thermoplastic plastic strand is detached from the carrier and then applied on an in particular plate-shaped substrate, preferably on a plate-shaped wood or furniture part, and fixed, so that an edge coating of the in particular plate-shaped substrate results or so that a composite of the in particular plate-shaped substrate with the edge coating applied and/or fixed thereto results.

If necessary or desired, post-processing, in particular homogenization, can also or alternatively be carried out after this step, for example using milling smoothening grinding, cutting and/or polishing.

In the next method step, a printing is applied by means of digital printing onto the thermoplastic plastic strand, in particular plastic profile strand or plastic film, or onto the edge coating.

According to another particular embodiment, the printing by means of digital printing can also be carried out before the thermoplastic plastic strand is brought from the carrier onto the plate-shaped substrate in particular.

### Printing Details (Digital Printing)

Printing is carried out on a print application device which, according to a particular embodiment, consists of six print heads arranged one behind the other, each followed by a UV lamp, wherein UV-curable colors are applied one after the other and UV-cured immediately. The colors are arranged in the following order or applied in this order: white (as base layer), cyan, magenta, yellow and black. This arrangement is in particular according to the so-called CMYK color model and the printing technique according to ISO 2846-1:2017.

The design for printing can be stored in the form of a predetermined image file in a corresponding program of the equipment used, wherein the image file comprises a high resolution. The image section can be selected manually—depending on the exact dimensions of the narrow side or edge to be printed—on a corresponding screen.

Alternatively, the design can also be automatically adapted to the substrate, for example by optically detecting the surface design of the substrate when the wood-based panel is fed into the system and automatically adapting the design for printing the narrow side exactly to the surface design.

### Heat-Adhesive Plastic Strand

The heat-adhesive (hot melt) thermoplastic plastic strand produced according to the invention, in particular plastic profile strand or plastic film, comprises in particular a reactive and/or a non-reactive (thermoplastic) plastic polymer, in particular adhesive. As a non-reactive adhesive, for example, an ethylene-vinyl acetate copolymer, ethylene-acrylate copolymer, polyamide, polyacrylate, polyolefin, polyester, in particular polylactide, or polyurethane-based plastic polymer or a corresponding mixture can be used. For example, a one-component (1K) or two-component (2K) polyurethane- or polyolefin-based plastic polymer or a mixture thereof can be used as the reactive adhesive.

In addition, the heat-adhesive thermoplastic plastic strand may contain other ingredients, for example, antioxidants, catalysts, resins, waxes, fillers, wetting agents, rheology modifiers, stabilizers, flame retardants, colorants, lubricants, plasticizers, and according to mixtures thereof.

For example, the following commercial products can be used as the material for the heat-adhesive (hot melt) thermoplastic plastic strand:
(i) non-reactive systems:
   Jowat-Toptherm® EP 12 237.60 (polyolefin-based),
   Jowatherm® 211.50 (polyamide-based),
   Jowat-Toptherm® 237.50 (polyolefin-based);
(ii) reactive systems:
   Jowatherm-Reaktant® 600.71 (polyurethane-based, 1-component system),
   Jowatherm-Reaktant® 629.70 (polyolefin-based, 1-component system)

### Influence of the Filler Quantity

To determine the influence of the filler quantity, a comparison series is carried out in each case with a polyamide-based adhesive and a polyurethane-based adhesive (both reactive and non-reactive). Narrow sides of wood-based substrates are coated according to the method of the invention as described above. In each case, the adhesives contain different amounts of calcium carbonate (CaCO₃) as filler, namely 0 wt. %, 1 wt. %, 5 wt. %, 10 wt. % and 20 wt. %, in each case based on the adhesive.

All adhesives are basically suitable for the method according to the invention and lead to the formation of an edge coating which is printable; i.e., the respective adhesives can each be processed according to the invention.

However, the series of tests (increasing amount of filler with otherwise identical adhesive and identical procedure) show in each case that at high throughput, the wear of the (extrusion) nozzle increases with increasing filler content, and that the processing properties, in particular the application and flowability, deteriorate, and that the bond strength, in particular the peel strength, adhesiveness, bond strength, shear strength, heat resistance, loss range and shear modulus, deteriorate.

### Further Explanations of a Typical Procedure

According to a typical procedure, various tests are carried out in the manner described below, wherein the aforementioned starting materials are used:

At first, an image file is loaded into a workflow, which is connected to the system, and automatically checked for defined criteria. The criteria include, for example, the resolution of the file, the color information it contains, and other definable parameters. In the event of an error message due to deviations from the specified criteria, corrections can be performed directly. The dimensions of the narrow edge to be coated are then entered directly, so that the image file is automatically adjusted to the corresponding size of the area to be printed. A printout or a check on a corresponding screen is also possible. The adapted image file is then made available to the printing device via a corresponding interface.

Subsequently, a wood-based panel to be coated is brought into the system and aligned. As an alternative to the method described above for providing the image file or design, the surface decor of the wood-based panel can also be detected optically when it is moved into the system and sent to the printing device in an automated process.

Then the narrow surface of the wood-based panel is moved along a slit nozzle or a roller, and the plastic polymer or adhesive on which the heat-adhesive thermoplastic plastic strand is based is applied homogeneously onto the entire narrow surface.

The applied plastic polymer or adhesive solidifies due to the cooling process while the wood-based panel is moved along, thus forming the thermoplastic plastic strand. When using a reactive plastic polymer, for example, UV lamps or heat sources can be arranged in particular downstream to initiate crosslinking.

The surface of the thermoplastic plastic strand is then automatically homogenized by various tools, for example milled, smoothened, ground, cut and/or polished.

The homogenized surface is then fed past the print application device, which consists of six print heads arranged one behind the other, each with a UV lamp behind it. The colors are applied one after the other in the order of: white (as base layer), cyan, magenta, yellow, black, and each is UV-cured directly. This procedure is according to DIN 2846-1.

Finally, a digital printable varnish is applied over the entire surface and smoothened or matt cured by a UV lamp. The varnish thus serves to finish and protect the underlying colors as well as the edge of the wood-based panel.

### REFERENCE SIGNS

A Producing apparatus
B Application and/or fixing apparatus
C Printing and/or ink application apparatus
a Method step (a)
b Method step (b)
c Method step (c)
a′ intermediate step or method step (a′)

1-78. (canceled)

79. A method for edge coating a plate-shaped substrate by applying an edge coating to at least one edge of a plate-shaped substrate,
wherein the method comprises the following method steps:
(a) producing a heat-adhesive thermoplastic plastic strand by using extrusion,
(b) applying and fixing of the thermoplastic plastic strand to at least one edge of the plate-shaped substrate in such a way that an edge coating of the plate-shaped substrate results, wherein a bond of the plate-shaped substrate with the edge coating applied and fixed thereto results,
(c) applying a printing onto the thermoplastic plastic strand,
wherein in method step (c) the application of the printing is carried out by multicolor printing using a plurality of printing inks of different colors and wherein the printing inks are applied onto the thermoplastic plastic strand in at least one of a dot-form and a screen-form, wherein the resulting coloring is produced by at least one of superpositioning and juxtapositioning the printing inks, and
wherein in method step (c) the application of the printing is carried out and controlled electronically in a computer-based way by using digital printing, wherein the print image to be produced in the course of the printing is configured and predetermined in an electronically-based way;
wherein, initially, the dimensions of the area of the plate-shaped substrate to be provided with the edge coating and with the printing are determined electronically in a computer-based way and, subsequently, the producing of the thermoplastic plastic strand and the applying and fixing of the thermoplastic plastic strand and the application of the printing are adapted each to the determined dimensions and are controlled each electronically in a computer-based way in accordance with the determined dimensions, and
wherein, at first, before the application of the printing and before method step (c). the optical configuration of the plate-shaped substrate is electronically determined and analyzed and, subsequently, in method step (c) the printing is configured and adapted in accordance with the optical configuration.

80. The method according to claim 79,
wherein the plate-shaped substrate is selected among plate-shaped wood parts and plate-shaped furniture part; and
wherein the thermoplastic plastic strand is selected among plastic profile strands, plastic films and plastic edge bands.

81. The method according to claim 79,
wherein the method comprising the overall operation of the method steps (a), (b) and (c) is carried out at least substantially continuously with at least substantially uninterrupted process operation.

82. The method according to claim 79,
wherein the method comprising the overall operation of the method steps (a), (b) and (c) is carried out discontinuously.

83. The method according to claim 79,
wherein, in method step (a), the thermoplastic plastic strand is produced, via extrusion, in a moldable and heat-adhesive state by using heat application to a temperature above the softening range of the thermoplastic plastic strand.

84. The method according to claim 79,
wherein, in method step (a), producing the heat-adhesive thermoplastic plastic strand is carried out by means of one of nozzle extrusion and roller discharge, wherein producing the thermoplastic resin strand takes place at a speed in the range from 1 m/min to 300 m/min.

85. The method according to claim 79,
wherein, in method step (b), the thermoplastic plastic strand is applied and fixed at least substantially over the entire surface and at least substantially without interruption and at least substantially homogeneously and with uniform thickness on the at least one edge of the plate-shaped substrate.

86. The method according to claim 79,
wherein the at least one edge of the plate-shaped substrate, before applying and fixing the thermoplastic plastic strand, is subjected to a surface activation by at least one of applying an adhesion promoter, using corona treatment and using plasma treatment.

87. The method according to claim 79,
wherein applying and fixing the thermoplastic plastic strand to the at least one edge of the plate-shaped substrate in method step (b) is carried out without using a surface activation.

88. The method according to claim 79,
wherein, after method step (a) and before method step (b), at least one intermediate step is carried out,
wherein, as an intermediate step, applying and detachable non-permanent fixing of the thermoplastic plastic strand on a carrier is carried out.

89. The method according to claim 79,
wherein, in method step (c), the application of the printing is carried out using at least one printing ink which is applied by means of at least one of ink-jet printing and laser printing, wherein the printing ink is UV-curable.

90. The method according to claim 79,
wherein, in method step (c), the thermoplastic plastic strand, after the application of the printing ink, is provided with a finishing layer.

91. The method according to claim 90,
wherein the finishing layer is applied as a sealing layer based on at least one lacquer, and
wherein the finishing layer is selected among transparent and translucent finishing layers.

92. The method according to claim 79,
wherein the overall composite resulting from the method and comprising the thermoplastic plastic strand bonded to the at least one edge of the plate-shaped substrate as an edge coating provided with the printing is characterized by at least one of the following properties:
a water-resistance in the range of from 3 to 5, determined according to IKEA datasheet TM 0002;
a heat-resistance in the range of from 3 to 5, determined according to IKEA datasheet TM 0002;
a resistance to humid climatic conditions at least substantially without any visually detectable and visible changes of the composite and of the edge coating, determined in accordance with AMK Module 2 datasheet 005 of April 2015;
an alternating climate resistance at least substantially without visually detectable and visible changes of the composite and of the edge coating, determined according to AMK Module 3 datasheet 005 of April 2015;
a resistance to water-vapor at least substantially without visually detectable and visible changes of the composite and of the edge coating, determined in accordance with AMK module 1 datasheet 005 of April 2015;
a UV-resistance according to gray scale in the range from 3 to 5, determined according to at least one of DIN EN ISO 4892-2:2013 and DIN EN 15187:2006;
a UV-resistance according to at least one of blue scale and wool scale in the range from 6 to 8, determined according to at least one of DIN EN ISO 4892-2:2013 and DIN EN 15187:2006.

93. A system for carrying out a method for edge coating a plate-shaped substrate by applying an edge coating to at least one edge of a plate-shaped substrate according to claim 79,
wherein the system comprises the following apparatuses A, B and C:
(A) at least one producing apparatus A configured for producing a heat-adhesive thermoplastic plastic strand by using extrusion;
(B) at least one application and fixing apparatus B configured for applying and fixing of the thermoplastic plastic strand to at least one edge of the plate-shaped substrate in such a way that an edge coating of the plate-shaped substrate results, wherein a bond of the plate-shaped substrate with the edge coating applied and fixed thereto results;
(C) at least one printing and ink-application apparatus C configured for applying a printing onto the thermoplastic plastic strand,
wherein the at least one printing and ink-application apparatus C is configured such that the application of the printing is carried out by multicolor printing using a plurality of printing inks of different colors and that the printing inks are applied onto the thermoplastic plastic strand in at least one of a dot-form and a screen-form,
wherein the resulting coloring is produced by at least one of superpositioning and juxtapositioning the printing inks, and
wherein the at least one printing and ink-application apparatus C is configured such that the application of the printing is carried out and controlled electronically in a computer-based way by using digital printing, wherein the print image to be produced in the course of the printing is configured and predetermined in an electronically-based way;
wherein the system is configured such that, initially, the dimensions of the area of the plate-shaped substrate to be provided with the edge coating and with the printing are determined electronically in a computer-based way and, subsequently, the producing of the thermoplastic plastic strand and the applying and fixing of the thermoplastic plastic strand and the application of the printing are adapted each to the determined dimensions and are controlled each electronically in a computer-based way in accordance with the determined dimensions, and
wherein the system is configured such that, at first, before the application of the printing, the optical configuration of the plate-shaped substrate is electronically determined and analyzed and, subsequently, the printing is configured and adapted in accordance with the optical configuration.

94. The system according to claim 93,
wherein the producing apparatus A and the application and fixing apparatus B are configured as a combined producing and application and fixing apparatus.

95. The system according to claim 93,
wherein the producing apparatus A, the application and fixing apparatus B and the printing and ink-application apparatus C are arranged in a joint process section and system line.

96. The system according to claim 93,
wherein the producing apparatus A, the application and fixing apparatus B and the printing and ink-application apparatus C are arranged at least partially in separate process sections and separate system lines.

97. The system according to claim 93,
wherein the printing and ink-application apparatus C comprises a plurality of printing and ink-application devices, wherein the printing and ink-application devices are connected and arranged one behind another in downstream process direction.

98. The system according to claim 93,
wherein the printing and ink-application apparatus C comprises at least one drying device configured for drying and UV-curing printing inks, wherein the respective drying device is arranged downstream in the process direction relative to a respective printing and ink-application device.

99. The system according to claim 93,
wherein the printing and ink-application apparatus C comprises at least one finish application device configured for applying a finishing layer.

100. The system according to claim 93,
wherein the printing and ink-application apparatus C comprises at least one finish application device configured for applying a finishing layer, wherein the finishing layer is applied as a sealing layer based on at least one lacquer and wherein the finishing layer is selected among transparent and translucent finishing layers.

101. The system according to claim 93,
wherein the system further comprises at least one surface processing apparatus configured for processing the surface of the thermoplastic plastic strand, wherein the surface processing apparatus is configured as one of a smoothing, grinding, milling, calibrating, cutting and polishing device and wherein the surface processing apparatus is arranged upstream of the printing and ink-application apparatus C in process direction.
